(19) United States
(12) Patent Application Publication
(10) Pub. No.: US 2026/0356729 A1
(43) Pub. Date: Nov. 12, 2026

(54) METHODS OF CONTROLLING STEADY-STATE CAPILLARY DIMENSIONS IN THE DRAWN HOLLOW-CORE FIBER MICROSTRUCTURE DURING PROCESS SCALE-UP

(71) Applicant: CORNING INCORPORATED, CORNING, NY (US)

(72) Inventors: Sushmit Sunil Kumar Goyal, Painted Post, NY (US); Shivam Sahu, Horseheads, NY (US); Mariia Serova, Espoo (FI)

(21) Appl. No.: 19/667,072

(22) Filed: May 4, 2026

Related U.S. Application Data
(60) Provisional application No. 63/801,501, filed on May 7, 2025.

(51) Int. Cl. C03B 37/03; C03B 37/012; C03B 37/014; C03B 37/025

(52) U.S. Cl. CPC C03B 37/032; C03B 37/01208; C03B 37/0124; C03B 37/0146; C03B 37/0253

(57) ABSTRACT

Methods of producing hollow-core optical fiber include feeding a hollow-core preform having an outer tube and inner tubes disposed within the outer tube into a draw furnace at a preform feed rate Uₚ in mm/min, and heating the hollow-core preform. The methods include drawing a hollow-core optical fiber from the hollow-core preform at a fiber draw rate U_{d} in mm/min, a draw tension τ in grams, a core pressure, and a capillary pressure to elongate the hollow-core preform to produce the hollow-core optical fiber having an outer cladding, a plurality of drawn capillaries disposed within the outer cladding, and an interior cavity. A drawn capillary outer diameter sensitivity ΔOD_{cap}, which is defined as a variation in the outer diameter OD_{cap} of the plurality of drawn capillaries of the hollow-core optical fiber per change in the excess pressure ΔP_{excess} satisfies specified scale-up relationships.

This application claims the benefit of priority to U.S. Provisional Patent Application Ser. No. 63/801,501 filed on May 7, 2025, the content of which is relied upon and incorporated herein by reference in its entirety.

### FIELD

The present disclosure generally relates to methods for producing optical fibers, and more specifically, to methods for producing hollow-core optical fibers.

### BACKGROUND

Hollow-core optical fibers are a new class of fibers that are attractive because of their optical properties of low loss, low attenuation, low latency, ultralow non-linearity, low flat dispersion, ultra broadband transmission, radiation hardness, and negligible Rayleigh backscattering. However, hollow-core optical fibers also suffer from the need for high precision of fiber microstructures. A typical design of an anti-resonant hollow core optical fiber may include an outer cladding along with two or more non-touching capillaries (or nested capillaries) attached on the inner surface of the outer cladding to define the hollow core through which the light is propagated. The light is propagated through the hollow core, and multiple low loss regions for light propagation can be identified. The propagation characteristics of the hollow-core optical fibers, such as anti-resonant optical fibers, are strongly related to the microstructures and dimensions thereof for effective guiding by the waveguide.

Hollow-core optical fibers can be produced by drawing a hollow-core preform into fiber. During the manufacture of the anti-resonant hollow-core optical fiber, especially when the starting preform sizes are increased for continuously drawing longer lengths of the fiber, the relative dimensions of the outer cladding and the capillaries may not be preserved from the preform to the fiber during the drawing of the fiber. For instance, the capillary dimensions obtained may deviate from target dimensions due to, e.g., the variation/instability in the processing conditions. Accordingly, it is important to understand the change in dimensions of the different components of the fiber during the draw process for scaling up and manufacturability.

### SUMMARY

Described herein are methods and processes addressing challenges in scaling up of the hollow-core optical fiber drawing process to large-volume manufacturing via the capped (or sealed) capillary method of manufacturing or the active pressure method. The inventors have recognized that the degree of change in microstructure from the preform to the fiber may be impacted by the target capillary size, target capillary thickness, size of the preform, and/or the size of the draw hot zone. The inventors further recognize that the surface tension and/or pressure forces inside the outer cladding tube during the draw process, as influenced by draw tension and/or draw down ratio, may also affect the dimensions of the outer cladding and the capillaries of the fiber drawn. Accordingly, the inventors have developed methods and processes for achieving target fiber microstructure dimensions with high precision, including but not limited to determining the process conditions for attaining desired microstructures in the hollow-core optical fiber from hollow-core preform of different sizes during scaleup, reducing variation in fiber microstructure dimensions during the drawing process for longer fiber lengths, which are all significant for scaleup and realizing low-cost large volume manufacturing of anti-resonant optical fibers. The various methods and processes described herein may maintain consistent capillary outside diameter along the length of the fiber, which may maintain a consistent mode field diameter and consistent confinement loss along the length of the drawn hollow-core optical fiber. The methods may also reduce or prevent mid-draw contact of capillaries, among other features.

In a first aspect disclosed herein, a method of producing a hollow-core optical fiber may comprise feeding a hollow-core preform into a draw furnace at a preform feed rate Uₚ in mm/min, wherein the hollow-core preform may comprise an outer tube and a plurality of inner tubes disposed within the outer tube, wherein the outer tube may have an outer diameter OD_{preform} (in mm) and an inner diameter ID_{preform} (in mm); heating the hollow-core preform in the draw furnace; drawing a hollow-core optical fiber from the hollow-core preform at a fiber draw rate U_{d} in mm/min, a draw tension τ in grams, a core pressure P_{core} in a hollow-core of the hollow-core preform, and a capillary pressure P_{cap} in the plurality of inner tubes, thereby elongating the outer tube and the plurality of inner tubes of the hollow-core preform to produce the hollow-core optical fiber having an outer cladding, a plurality of drawn capillaries disposed within the outer cladding, and an interior cavity, wherein: the plurality of drawn capillaries of the hollow-core optical fiber have an outer diameter OD_{cap} (in μm); an excess pressure P_{excess} (in psig) is equal to a difference between the core pressure P_{core} (in psig) and the capillary pressure P_{cap} (in psig); and a drawn capillary outer diameter sensitivity ΔOD_{cap} (in μm), which is defined as a variation in the outer diameter OD_{cap} of the plurality of drawn capillaries of the hollow-core optical fiber per change in the excess pressure ΔP_{excess}, may satisfy the following:

0.90×(ΔP_{excess}×A×54677×τ⁻¹)≤ΔOD_{cap}≤1.10×(ΔP_{excess}×A×54677×τ⁻¹)
where A is a scaling factor and

$$A = \frac{O {D}_{preform}^{2} - {ID}_{preform}^{2}}{225} ;$$

and τ is the draw tension in grams.

A second aspect disclosed herein may include the first aspect, wherein the plurality of drawn capillaries may have a target thickness t_{cap} of about 538.5 nm and a target outer diameter OD_{cap} of about 26.0 μm.

A third aspect of the present disclosure may include any one of the first or second aspects, wherein the ΔP_{excess} may be from about 0.001 psig to about 0.02 psig.

A fourth aspect disclosed herein may include any one of the first through third aspects, wherein the outer cladding of the hollow-core optical fiber may have a cladding outer diameter OD_{cladding} of about 180 μm and a cladding inner diameter ID_{cladding} of about 105 μm.

A fifth aspect disclosed herein may include any one of the first through fourth aspects, wherein the drawn capillary outer diameter sensitivity ΔOD_{cap} (in μm) may satisfy the following:

$$0.90 \times ( Δ {P}_{e x c e s s} \times 3.78011 \times \frac{1}{σ} \times \frac{{U}_{d}}{{U}_{p}} ) \leq Δ {OD}_{c a p} \leq 1.10 \times ( Δ {P}_{e x c e s s} \times 3.78011 \times \frac{1}{σ} \times \frac{{U}_{d}}{{U}_{p}} )$$

where σ is a draw stress in MPa, U_{d} is the fiber draw rate in mm/min, and Uₚ is the preform feed rate in mm/min.

A sixth aspect may include any one of the first through fourth aspects, wherein the drawn capillary outer diameter sensitivity ΔOD_{cap} (in μm) may satisfy the following:

0.95×(ΔP_{excess}×A×54677×τ⁻¹)≤ΔOD_{cap}≤1.05×(ΔP_{excess}×A×54677×τ⁻¹).

In a seventh aspect disclosed herein, a method of producing a hollow-core optical fiber may comprise feeding a hollow-core preform into a draw furnace at a preform feed rate, wherein the hollow-core preform comprises an outer tube and a plurality of inner tubes disposed within the outer tube, wherein the outer tube has an outer diameter OD_{preform} and an inner diameter ID_{preform}; heating the hollow-core preform in the draw furnace; drawing a hollow-core optical fiber from the hollow-core preform at a fiber draw rate, a draw stress, a draw tension τ, a core pressure P_{core} in a hollow-core of the hollow-core preform, and a capillary pressure P_{cap} in the plurality of inner tubes, thereby elongating the outer tube and the plurality of inner tubes of the hollow-core preform to produce the hollow-core optical fiber having an outer cladding, a plurality of drawn capillaries disposed within the outer cladding, and an interior cavity, wherein: the plurality of drawn capillaries of the hollow-core optical fiber have an outer diameter OD_{cap} (in μm); an excess pressure P_{excess} (in psig) is equal to a difference between the core pressure P_{core} (in psig) and the capillary pressure P_{cap} (in psig); and a drawn capillary outer diameter sensitivity ΔOD_{cap} (in μm), which is defined as a variation in the outer diameter OD_{cap} of the plurality of drawn capillaries of the hollow-core optical fiber per change in the excess pressure ΔP_{excess}, may satisfy the following:

$$0.90 \times ( Δ {P}_{e x c e s s} \times 3.78011 \times \frac{1}{σ} \times \frac{{U}_{d}}{{U}_{p}} ) \leq Δ {OD}_{c a p} \leq 1.10 \times ( Δ {P}_{e x c e s s} \times 3.78011 \times \frac{1}{σ} \times \frac{{U}_{d}}{{U}_{p}} )$$

where σ is the draw stress in MPa, U_{d} is the fiber draw rate in mm/min, and Uₚ is the preform feed rate in mm/min.

An eighth aspect may include the seventh aspect, wherein the plurality of drawn capillaries may have a target thickness of about 538.5 nm and a target outer diameter OD_{cap} of about 26.0 μm.

A ninth aspect may include any one of the seventh or eighth aspects, wherein the ΔP_{excess} may be from about 0.001 psig to about 0.02 psig.

A tenth aspect may include any one of the seventh through ninth aspects, wherein the outer cladding of the hollow-core optical fiber may have a cladding inner diameter ID_{cladding} of about 105 μm.

An eleventh aspect may include any one of the seventh through tenth aspects, wherein the outer cladding may have a cladding outer diameter OD_{cladding} of from about 150 μm to about 300 μm.

A twelfth aspect of the present disclosure may include any one of the seventh through eleventh aspects, wherein the hollow-core optical fiber may have a cladding outer diameter OD_{cladding} of about 180 μm and the drawn capillary outer diameter sensitivity ΔOD_{cap} (in μm) may satisfy the following:

0.90×(ΔP_{excess}×A×54677×τ⁻¹)≤ΔOD_{cap}≤1.10×(ΔP_{excess}×A×54677×τ⁻¹)
where A is a scaling factor and

$$A = \frac{{OD}_{preform}^{2} - {ID}_{preform}^{2}}{225} ;$$

and τ is the draw tension in grams.

A thirteenth aspect of the present disclosure may include any one of the seventh through eleventh aspects, wherein the drawn capillary outer diameter sensitivity ΔOD_{cap} (in μm) may satisfy the following:

$$0.95 \times ( Δ {P}_{e x c e s s} \times 3.78011 \times \frac{1}{σ} \times \frac{{U}_{d}}{{U}_{p}} ) \leq Δ {OD}_{c a p} \leq 1.05 \times ( Δ {P}_{e x c e s s} \times 3.78011 \times \frac{1}{σ} \times \frac{{U}_{d}}{{U}_{p}} ) .$$

In a fourteenth aspect disclosed herein, a method of producing a hollow-core optical fiber may comprise feeding a hollow-core preform into a draw furnace at a preform feed rate, wherein the hollow-core preform comprises an outer tube and a plurality of inner tubes disposed within the outer tube, wherein the outer tube has an outer diameter OD_{preform} and an inner diameter ID_{preform}; heating the hollow-core preform in the draw furnace; drawing a hollow-core optical fiber from the hollow-core preform at a fiber draw rate, a draw tension τ, a core pressure P_{core} in a hollow-core of the hollow-core preform, and a capillary pressure P_{cap} in the plurality of inner tubes, thereby elongating the outer tube and the plurality of inner tubes of the hollow-core preform to produce the hollow-core optical fiber having an outer cladding, a plurality of drawn capillaries disposed within the outer cladding, and an interior cavity, wherein: the plurality of drawn capillaries of the hollow-core optical fiber have an outer diameter OD_{cap} (in μm) and a thickness t_{cap} (in nm); an excess pressure P_{excess} (in psig) is equal to a difference between the core pressure P_{core} (in psig) and the capillary pressure P_{cap} (in psig); and a drawn capillary outer diameter sensitivity ΔOD_{cap} (in μm), which is defined as a variation in the outer diameter OD_{cap} of the plurality of drawn capillaries of the hollow-core optical fiber per change in the excess pressure ΔP_{excess}, may satisfy the following:

$$0.90 \times ( Δ {P}_{e x c e s s} \times \frac{538.5}{{t}_{c a p}} \times ( 3.78011 \times \frac{1}{σ} \times \frac{{U}_{d}}{{U}_{p}} ) ) \leq Δ {OD}_{c a p} \leq 1.1 \times ( Δ {P}_{e x c e s s} \times \frac{538.5}{{t}_{c a p}} \times ( 3.78011 \times \frac{1}{σ} \times \frac{{U}_{d}}{{U}_{p}} ) )$$

where σ is the draw stress in MPa, U_{d} is the fiber draw rate in mm/min, Uₚ is the preform feed rate in mm/min, and t_{cap} is a thickness of the plurality of drawn capillaries.

A fifteenth aspect may include the fourteenth aspect, wherein the plurality of drawn capillaries may have a target outer diameter OD_{cap} of about 26.0 μm.

A sixteenth aspect may include any one of the fourteenth or fifteenth aspects, wherein the ΔP_{excess} may be from about 0.001 psig to about 0.02 psig.

A seventeenth aspect may include any one of the fourteenth through sixteenth aspects, wherein the hollow-core optical fiber may have a cladding inner diameter ID_{cladding} of about 105 μm.

An eighteenth aspect may include any one of the fourteenth through seventeenth aspects, wherein the outer cladding may have a cladding outer diameter OD_{cladding} of from about 150 μm to about 300 μm.

A nineteenth aspect may include any one of the fourteenth through eighteenth aspects, wherein the outer cladding may have a cladding outer diameter OD_{cladding} of about 180 μm and the drawn capillary outer diameter sensitivity ΔOD_{cap} (in μm) may satisfy the following:

$$0.90 \times ( Δ {P}_{e x c e s s} \times \frac{538.5}{{t}_{c a p}} \times ( A \times 54677 \times {τ}^{- 1} ) ) \leq Δ {OD}_{c a p} \leq 1.1 \times ( Δ {P}_{e x c e s s} \times \frac{538.5}{{t}_{c a p}} \times ( A \times 54677 \times {τ}^{- 1} ) )$$

where A is a scaling factor and

$$A = \frac{O {D}_{p r e f o r m}^{2} - {ID}_{p r e f o r m}^{2}}{225} ;$$

τ is the draw tension in grams; and t_{cap} is the thickness of the plurality of drawn capillaries.

A twentieth aspect may include the nineteenth aspect, wherein the plurality of drawn capillaries may have a target thickness t_{cap} of 538.5 nm, and the drawn capillary outer diameter sensitivity ΔOD_{cap} (in μm) may satisfy the following:

0.90×(ΔP_{excess}×(A×54677×τ⁻¹))≤ΔOD_{cap}≤1.10×(ΔP_{excess}×(A×54677×τ⁻¹))
where A is a scaling factor and

$$A = \frac{O {D}_{p r e f o r m}^{2} - {ID}_{p r e f o r m}^{2}}{225} ;$$

and τ is the draw tension in grams.

A twenty-first aspect may include any one of the fourteenth through eighteenth aspects, wherein the drawn capillary outer diameter sensitivity ΔOD_{cap} (in μm) may satisfy the following:

$$0.95 \times ( Δ {P}_{e x c e s s} \times \frac{538.5}{{t}_{c a p}} \times ( 3.78011 \times \frac{1}{σ} \times \frac{{U}_{d}}{{U}_{p}} ) ) \leq Δ {OD}_{c a p} \leq 1.05 \times ( Δ {P}_{e x c e s s} \times \frac{538.5}{{t}_{c a p}} \times ( 3.78011 \times \frac{1}{σ} \times \frac{{U}_{d}}{{U}_{p}} ) ) .$$

In a twenty-second aspect disclosed herein, a method of producing a hollow-core optical fiber may include feeding a hollow-core preform into a draw furnace at a preform feed rate, wherein the hollow-core preform comprises an outer tube and a plurality of inner tubes disposed within the outer tube, wherein the outer tube has an outer diameter OD_{preform} and an inner diameter ID_{preform}; heating the hollow-core preform in the draw furnace; drawing a hollow-core optical fiber from the hollow-core preform at a fiber draw rate, a draw tension τ, a core pressure P_{core} in a hollow-core of the hollow-core preform, and a capillary pressure P_{cap} in the plurality of inner tubes, thereby elongating the outer tube and the plurality of inner tubes of the hollow-core preform to produce the hollow-core optical fiber having an outer cladding, a plurality of drawn capillaries disposed within the outer cladding, and an interior cavity, wherein: the plurality of drawn capillaries of the hollow-core optical fiber have an outer diameter OD_{cap} (in μm); an excess pressure P_{excess} (in psig) is equal to a difference between the core pressure P_{core} (in psig) and the capillary pressure P_{cap} (in psig); and a drawn capillary outer diameter sensitivity ΔOD_{cap} (in μm), which is defined as a variation in the outer diameter OD_{cap} of the plurality of drawn capillaries of the hollow-core optical fiber per change in the excess pressure ΔP_{excess}, may satisfy the following formula:

$$0.90 \times ( Δ {P}_{e x c e s s} \times {( \frac{{OD}_{c a p}}{26.0} )}^{2} \times ( 3.78011 \times \frac{1}{σ} \times \frac{{U}_{d}}{{U}_{p}} ) ) \leq Δ {OD}_{c a p} \leq 1.1 \times ( Δ {P}_{e x c e s s} \times {( \frac{{OD}_{c a p}}{26.0} )}^{2} \times ( 3.78011 \times \frac{1}{σ} \times \frac{{U}_{d}}{{U}_{p}} ) )$$

where σ is the draw stress in MPa, U_{d} is the fiber draw rate in mm/min, Uₚ is the preform feed rate in mm/min, and OD_{cap} is the target outer diameter of the plurality of drawn capillaries.

A twenty-third aspect may include the twenty-second aspect, wherein the plurality of drawn capillaries may have a target thickness t_{cap} of about 538.5 nm.

A twenty-fourth aspect may include any one of the twenty-second or twenty-third aspects, wherein the ΔP_{excess} may be from about 0.001 psig to about 0.02 psig.

A twenty-fifth aspect may include any one of the twenty-second through twenty-fourth aspects, wherein the hollow-core optical fiber may have a cladding inner diameter ID_{cladding} of about 105 μm.

A twenty-sixth aspect may include any one of the twenty-second through twenty-fifth aspects, wherein the outer cladding may have a cladding outer diameter OD_{cladding} of from about 150 μm to about 300 μm.

A twenty-seventh aspect may include any one of the twenty-second through twenty-sixth aspects, wherein the outer cladding may have a cladding outer diameter OD_{cladding} of about 180 μm and the drawn capillary outer diameter sensitivity ΔOD_{cap} (in μm) satisfies the following:

$$0.90 \times ( Δ {P}_{e x c e s s} \times {( \frac{{OD}_{c a p}}{26.0} )}^{2} \times ( A \times 54677 \times {τ}^{- 1} ) ) \leq Δ {OD}_{c a p} \leq 1.1 \times ( Δ {P}_{e x c e s s} \times {( \frac{{OD}_{c a p}}{26.0} )}^{2} \times ( A \times 54677 \times {τ}^{- 1} ) )$$

where A is a scaling factor and

$$A = \frac{O {D}_{p r e f o r m}^{2} - {ID}_{p r e f o r m}^{2}}{225} ;$$

τ is the draw tension in grams, and OD_{cap} is the target outside diameter of the plurality of drawn capillaries.

A twenty-eighth aspect may include the twenty-seventh aspect, wherein the plurality of drawn capillaries may have a target outer diameter OD_{cap} of about 26.0 μm and the drawn capillary outer diameter sensitivity ΔOD_{cap} (in μm) may satisfy the following:

0.90×(ΔP_{excess}×(A×54677×τ⁻¹))≤ΔOD_{cap}≤1.10×(ΔP_{excess}×(A×54677×τ⁻¹))
where A is a scaling factor and

$$A = \frac{O {D}_{p r e f o r m}^{2} - {ID}_{p r e f o r m}^{2}}{225} ;$$

τ is the draw tension in grams.

A twenty-ninth aspect may include any one of the twenty-second through twenty-sixth aspects, wherein the drawn capillary outer diameter sensitivity ΔOD_{cap} (in μm) may satisfy the following:

$$0.95 \times ( Δ {P}_{e x c e s s} \times {( \frac{{OD}_{c a p}}{26.0} )}^{2} \times ( 3.78011 \times \frac{1}{σ} \times \frac{{U}_{d}}{{U}_{p}} ) ) \leq Δ {OD}_{c a p} \leq 1.05 \times ( Δ {P}_{e x c e s s} \times {( \frac{{OD}_{c a p}}{26.0} )}^{2} \times ( 3.78011 \times \frac{1}{σ} \times \frac{{U}_{d}}{{U}_{p}} ) ) .$$

A thirtieth aspect may include any one of the first through twenty-ninth aspects, wherein the draw tension τ in grams under which the hollow-core optical fiber is drawn may be greater than or equal to about 50 g and less than or equal to about 600 g.

A thirty-first aspect may include any one of the first through thirtieth aspects, wherein the differential core pressure P_{core} in a hollow core of the outer tube of the hollow-core preform may be greater than or equal to 0.01 psig and less than or equal to 2 psig.

A thirty-second aspect may include any one of the first through thirty-first aspects, wherein the fiber draw speed (U_{d} divided by 60,000) may be greater than or equal to about 0.1 m/s and less than or equal to about 60 m/s, or more preferably greater than or equal to about 1 m/s and less than or equal to about 60 m/s.

A thirty-third aspect may include any one of the first through thirty-second aspects, wherein the preform feed rate Uₚ may be greater than or equal to 5 mm/min and less than or equal to 100 mm/min.

A thirty-fourth aspect may include any one of the first through thirty-third aspects, wherein the outer diameter of the outer tube of the hollow-core preform (OD_{preform}=2×Rₚ) may be greater than or equal to about 15 mm and less than or equal to about 100 mm.

A thirty-fifth aspect may include any one of the first through thirty-fourth aspects, wherein the inner diameter of the outer tube of the hollow-core preform (ID_{Preform}=2×rₚ) may be less than the outer diameter of the outer tube and the inner diameter of the outer tube may be greater than or equal to about 4 mm and less than or equal to about 20 mm.

A thirty-sixth aspect may include any one of the first through thirty-fifth aspects, wherein the draw furnace may comprise a hot zone having an axial length greater than or equal to 3 cm and less than or equal to 50 cm.

A thirty-seventh aspect may include any one of the first through thirty-sixth aspects, wherein the hollow-core preform further may comprise a nested capillary disposed within each of the plurality of inner tubes and in contact with an inner surface of each of the plurality of inner tubes of the hollow-core preform, wherein the drawing further elongates the nested capillaries of the hollow-core preform to form a drawn nested capillary of the hollow-core optical fiber in contact with an inner surface of each of the plurality of drawn capillaries of the hollow-core optical fiber.

Additional features and advantages of the methods disclosed herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIGS. 1A and 1B schematically depict cross-sectional views of hollow-core optical fibers, according to embodiments shown and described herein;

FIGS. 2A and 2B schematically depict cross-sectional views of exemplary hollow-core preforms for drawing the hollow-core optical fibers of FIG. 1A and FIG. 1B, respectively, according to embodiments shown and described herein;

FIG. 3 schematically depicts an exemplary drawing system, according to embodiments shown and described herein;

FIG. 4 graphically depicts deviation in capillary outer diameter (OD) (y-axis) as a function of deviation in excess pressure (x-axis) for deviations in excess pressure of up to about 0.01 psi for nominal capillary OD of 26 μm and capillary thickness of 538.5 nm, according to embodiments shown and described herein;

FIG. 5 graphically depicts deviation in capillary outer diameter (OD) (y-axis) as a function of deviation in excess pressure (x-axis) for deviations in excess pressure of up to about 0.001 psi, according to embodiments shown and described herein;

FIG. 6 graphically depicts a slope of change in capillary OD per change in excess pressure (i.e., capillary OD sensitivity) (y-axis) as a function of draw tension (x-axis) for capillary wall thickness of 538.5 nm and capillary OD of 26 μm, according to embodiments shown and described herein;

FIG. 7 graphically depicts capillary OD sensitivity (y-axis) as a function of draw down ratio (x-axis), according to embodiments shown and described herein;

FIG. 8 graphically depicts pre-exponential factor (y-axis) as a function of draw stress (x-axis), according to embodiments shown and described herein;

FIG. 9 graphically depicts capillary OD sensitivity (y-axis) as a function of draw tension (x-axis) for capillary wall thickness of 1077 nm and capillary OD of 26 μm, according to embodiments shown and described herein;

FIG. 10 graphically depicts capillary OD sensitivity (y-axis) as a function of draw tension (x-axis) for capillary wall thickness of 538.5 nm and capillary OD of 20 μm, according to embodiments shown and described herein;

FIG. 11 graphically depicts capillary OD sensitivity (y-axis) as a function of draw tension (x-axis) for capillary wall thickness of 538.5 nm and capillary OD of 32 μm, according to embodiments shown and described herein;

FIG. 12 graphically depicts drawn capillary outer diameter (OD_{cap}) (left y-axis), drawn capillary inner diameter (ID_{cap}) (left y-axis), and drawn capillary thickness (right y-axis) as functions of ΔP_{excess} (x-axis) for drawing a hollow-core preform having outer tube outer diameter of 17 mm, according to embodiments shown and described herein; and

FIG. 13 graphically depicts drawn capillary outer diameter (OD_{cap}) (left y-axis), drawn capillary inner diameter (ID_{cap}) (left y-axis), and drawn capillary thickness (right y-axis) as functions of ΔP_{excess} (x-axis) for drawing a hollow-core preform having outer tube outer diameter of 25 mm, according to embodiments shown and described herein.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In embodiments, a method of producing a hollow-core optical fiber may comprise feeding a hollow-core preform into a draw furnace at a preform feed rate Vₚ in mm/min, wherein the hollow-core preform comprises an outer tube and a plurality of inner tubes disposed within the outer tube, wherein the outer tube has an outer diameter OD_{preform} and an inner diameter ID_{preform}. The method may include heating the hollow-core preform in the draw furnace and drawing a hollow-core optical fiber from the hollow-core preform at a fiber draw rate Va in mm/min, a draw tension τ in grams, a core pressure P_{core} in a hollow-core of the hollow-core preform, and a capillary pressure P_{cap} in the plurality of inner tubes, thereby elongating the outer tube and the plurality of inner tubes of the hollow-core preform to produce the hollow-core optical fiber having an outer cladding, a plurality of drawn capillaries disposed within the outer cladding, and an interior cavity. The plurality of drawn capillaries of the hollow-core optical fiber may have an outer diameter OD_{cap} (in μm) and an excess pressure P_{excess} of the fiber draw may be equal to a difference between the core pressure P_{core} and the capillary pressure P_{cap} during the fiber draw. A drawn capillary outer diameter sensitivity ΔOD_{cap} (in μm), which is defined as a variation in the outer diameter OD_{cap} of the plurality of drawn capillaries of the hollow-core optical fiber per change in the excess pressure ΔP_{excess}, may satisfy the following relationship:

ΔOD_{cap}=ΔP_{excess}×A×54677×τ⁻¹
where A is a scaling factor and

$$A = \frac{O {D}_{p r e f o r m}^{2} - {ID}_{p r e f o r m}^{2}}{225} ;$$

and τ is the draw tension in grams. In embodiments, the drawn capillary outer diameter sensitivity may satisfy other relationships based on draw down ratio, target capillary thickness, and target capillary outer diameter, as further discussed herein.

In this specification and in the claims which follow, “greater than or equal to” and “≥” are used interchangeably, “less than or equal to” and “≤” are used interchangeably, “greater than” and “>” are used interchangeably, and “less than” and “≤” are used interchangeably. When a parameter is described as greater than or equal to (or simply, ≥) a value, the parameter may be greater than (>) the referenced value or equal to (=) the referenced value. Similarly, when a parameter is described as less than or equal to (or simply, ≤) a value, the parameter may be less than (<) the referenced value or equal to (=) the referenced value.

Directional terms as used herein—for example up, down, right, left, front, back, top, bottom—are made only with reference to the figures as drawn and are not intended to imply absolute orientation.

Various components described herein may be referred to as “directly connected” or “indirectly connected.” Components are directly connected when they are joined to one another with no intervening structure. Components may be joined by fusing, melting, welding, soldering, adhesives, or any other suitable attachment means. Components are “indirectly connected” when they are joined to one another with intervening structure. Examples of intervening structure include welding aids (e.g. frits, solders, fluxes), adhesives, and bonding materials. In some embodiments, components connected indirectly are connected only by a welding aid, adhesive, or bonding material. The term “connected” means “directly connected” or “indirectly connected.” Components “directly connected” to one another are said to be in direct contact with each other. Components “indirectly connected” to one another are said to be in indirect contact with each other. Components “connected” to one another are in direct or indirect contact with each other.

As used herein, the terms “upstream” and “downstream” refer to the relative positioning of unit operations with respect to the direction of flow of the process streams. A first unit operation of a system may be considered “upstream” of a second unit operation if process streams flowing through the system encounter the first unit operation before encountering the second unit operation. Likewise, a second unit operation may be considered “downstream” of the first unit operation if the process streams flowing through the system encounter the first unit operation before encountering the second unit operation.

As used herein, the term “linear” refers to relative distances/lengths between points. A “linear” distance/length may refer to a distance between two points along a straight line.

As used herein, the singular forms “a,” “an” and “the” include plural referents in addition to the single referent unless the context clearly dictates otherwise. Thus, for example, reference to “a” component includes aspects having one such component as well as two or more such components, unless the context clearly indicates otherwise.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

Reference will now be made in detail to various embodiments. Whenever possible, the same reference numerals will be used throughout the drawings to refer to the same or like parts.

### Hollow-Core Optical Fiber

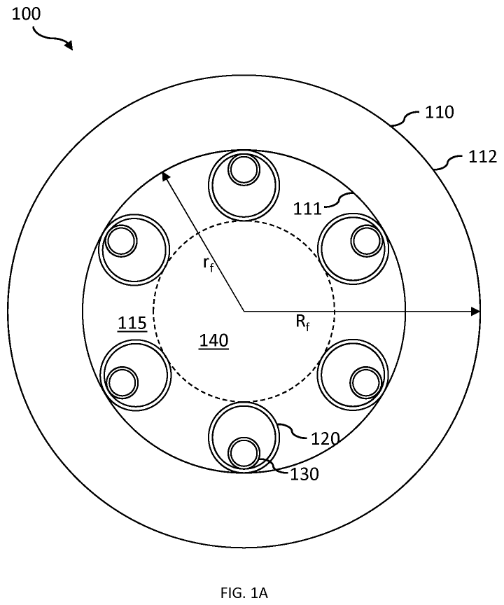

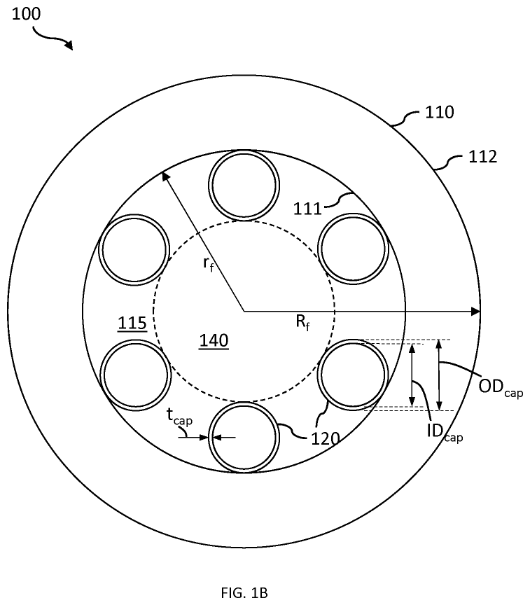

FIG. 1A schematically illustrates an example of a hollow-core optical fiber 100. The hollow-core optical fiber 100 may include an outer cladding 110. The outer cladding 110 may include an inner surface 111 defining an interior cavity 115 and an inner radius r_{f} of the outer cladding 110. The outer cladding 110 may include an outer surface 112 defining an outer radius R_{f} of the outer cladding 110. The hollow-core optical fiber 100 may further include two or more (e.g., two, three, four, five, six, or more) cladding elements, such as capillaries 120, inside the interior cavity 115 of the outer cladding 110. The hollow-core optical fiber 100 may include capillaries 120 as cladding elements or cladding elements that include capillaries 120. The capillaries 120 may be in contact with and/or attached to the inner surface 111 of the outer cladding 110. The capillaries 120 may not be in contact with each other and may be evenly spaced angularly along the inner surface 111 of the outer cladding 110 and may extend the length of the hollow-core optical fiber 100. The capillaries 120 may be referred to herein as “drawn capillaries.” In embodiments, the cladding elements of the hollow-core optical fiber 100 may also include nested capillaries 130 with each nested capillary 130 disposed inside a capillary 120 and in contact with and/or attached to an inner surface of the capillary 120. In embodiments, the hollow-core optical fiber 100 may not include nested capillaries 130, such as shown in FIG. 1B. The cladding elements of the hollow-core optical fiber 100, e.g., the capillaries 120 and/or the nested capillaries 130, may surround and define a hollow core 140 of the hollow-core optical fiber 100. The hollow core 140 may be the central portion of the interior cavity 115 and may correspond to the region of the hollow-core optical fiber 100 in which optical signals may be primarily confined and propagate. The capillaries 120 and/or nested capillaries act to confine light to the hollow core 140 of the hollow-core optical fiber 100.

Referring to FIG. 1B, each of the capillaries 120 may have a capillary inner surface defining a capillary inner diameter ID_{cap}. Each of the capillaries 120 may have a capillary outer surface defining a capillary outer diameter OD_{cap}. Each of the capillaries 120 may have a capillary thickness t_{cap} defined as an average radial distance between the capillary inner surface and capillary outer surface. In embodiments, the outer cladding 110, the capillaries 120, and/or the nested capillaries 130 may include silica glass and/or silica-based glass (i.e., silica glass comprising one or more dopants).

### Hollow-Core Preform

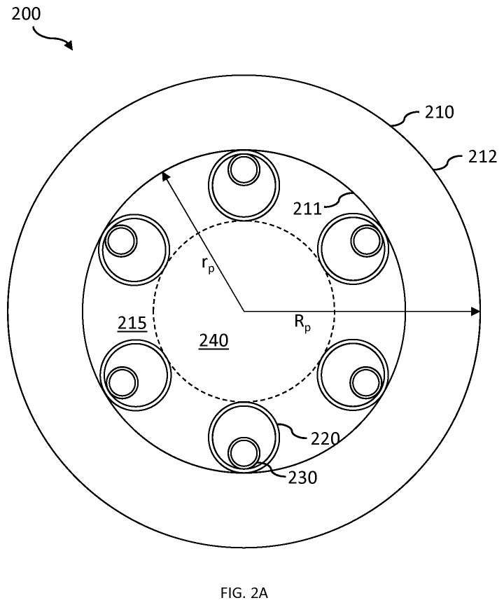

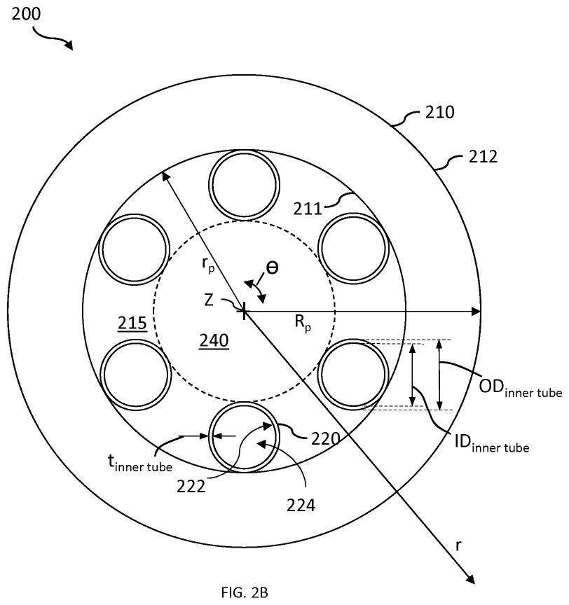

The hollow-core optical fiber 100 may be produced by drawing a hollow-core preform into fiber. FIGS. 2A and 2B schematically illustrate cross-sectional views of non-limiting examples of hollow-core preforms 200 that may be utilized for producing the hollow-core optical fiber 100 shown in FIGS. 1A and 1B, respectively. The hollow-core preform 200 may include an outer tube 210. The outer tube 210 may include an inner surface 211 defining an interior cavity 215 and an inner radius rₚ of the outer tube 210, and an outer surface 212 defining an outer radius Rₚ of the outer tube 210.

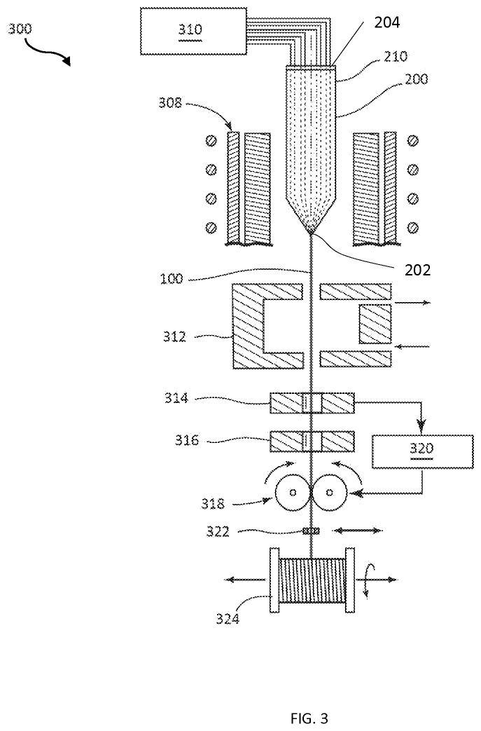

The hollow-core preform 200 may further include two or more (e.g., two, three, four, five, six, or more) inner tubes 220 inside the interior cavity 215 of the outer tube 210. In embodiments, the inner tubes 220 may be in contact with and/or attached to the inner surface 211 of the outer tube 210. In embodiments, the inner tubes 220 may not be in contact with each other and may be evenly spaced angularly around the inner surface 211 of the outer tube 210. Each of the inner tubes 220 may have an inner diameter (ID_{inner tube}), and outer diameter (OD_{inner tube}), and a thickness (t_{inner tube}) In embodiments, such as shown in FIG. 2A, the hollow-core preform 200 may also include two or more nested tubes 230 with each nested tube 230 disposed inside one of the inner tubes 220 and in contact with and/or attached to an inner surface of the inner tube 220. In embodiments, the hollow-core preform 200 may not include nested tubes 230, such as shown in FIG. 2B. The inner tubes 220 may surround and define a hollow section 240 that may be the central portion of the interior cavity 215 and correspond to the hollow core 140 of the hollow-core optical fiber 100 that may be drawn from the hollow-core preform 200. In embodiments, the outer tube 210, the inner tubes 220, and/or the nested tubes 230 may include silica glass and/or silica-based glass (i.e., silica glass comprising one or more dopants). Referring now to FIG. 3, the hollow-core preform 200 may have a draw end 202 and an upper end 204.

Referring to FIG. 2B, each inner tube 220 may comprise a wall 222 defining an internal opening 224. In embodiments, at least one internal opening 224 of one or more of the inner tubes 220 may have a sealed end. In embodiments, at least two of the inner tubes 220 may have an internal opening 224 having a sealed end. For example, without limitation, at least two, at least three, at least four, at least five or even at least six of the inner tubes 220 may have an internal opening 224 having a sealed end. In embodiments in which multiple inner tubes 220 have an internal opening 224 having a sealed end, the sealed end of each inner tube 220 may be on the same end of the hollow-core preform 200. Inner tubes having a sealed end are referred to herein as “sealed inner tubes”. Inner tubes lacking a sealed end are referred to herein as “open inner tubes”. Open inner tubes have open ends. In embodiments, hollow-core preform 200 includes only sealed inner tubes, only open inner tubes, or a combination of sealed inner tubes and open inner tubes. Unless otherwise specified, reference numeral 220 refers to either a sealed inner tube or an open inner tube. When a distinction between sealed inner tubes and open inner tubes is needed in the description, the terms “sealed” and “open” will be added as qualifiers when referring to inner tubes 220 (e.g. “sealed inner tubes 220” or “open inner tubes 220”).

In embodiments, interior cavity 215 has a sealed end. An interior cavity 215 with a sealed end is referred to herein as a “sealed interior cavity”. An interior cavity 215 lacking a sealed end is referred to herein as an “open interior cavity”. In embodiments, hollow-core preform 200 may include an open interior cavity 215 and one or more sealed inner tubes 220. In embodiments, hollow-core preform 200 may include a sealed interior cavity 215 and one or more sealed inner tubes 220. In embodiments, hollow-core preform 200 may include a sealed interior cavity 215 and one or more open inner tubes 220. In embodiments with a sealed inner tube or a sealed interior cavity, the inner tube or interior cavity may have one sealed end and one open end. The one sealed end is may be the end opposite the draw end of hollow-core preform 200.

In embodiments, the interior cavity 215, internal openings 224 of the inner tubes 220, and/or the space between inner tubes 220 comprise a gas. For example, without limitation, the interior cavity 215, internal openings 224 of the inner tubes 220, and/or the space between inner tubes 220 may comprise air. In embodiments, the interior cavity 215, internal openings 224 of the inner tubes 220, and/or the space between inner tubes 220 may consist of or consist essentially of air. In embodiments, the interior cavity 215, internal openings 224 of the inner tubes 220, and/or the space between inner tubes 220 may comprise, consist or, or consists essentially of an inert gas. As described herein, an inert gas refers to any gas that is non-reactive during the drawing process. Inert gasses may include, but are not limited to, nitrogen, argon, helium, and combinations thereof. In embodiments, the interior cavity 215, internal openings 224 of the inner tubes 220, and/or the space between inner tubes 220 may comprise, consist of, or consist essentially of an inert gas selected from the group consisting of nitrogen, argon, helium, and combinations thereof.

### Fiber Drawing System

Referring now to FIG. 3, one embodiment of a drawing system 300 that may be utilized to produce the hollow-core optical fiber 100 from the hollow-core preform 200 is schematically depicted. The drawing system 300 may include a draw furnace 308 configured for receiving and heating the hollow-core preform 200, thereby subjecting the hollow-core preform 200 to a draw temperature. After, and as, the hollow-core preform 200 is subjected to the draw temperature, the hollow-core preform 200 may be necked down, and the hollow-core optical fiber 100 may be drawn from the hollow-core preform 200. The draw furnace 308 may include a hot zone, which is defined as the axial span of the heating elements that are used to heat up the preform for drawing into fiber. An axial length of the hot zone may be greater than or equal to (i.e., ≥) about 3 cm and less than or equal to (i.e., ≤) about 50 cm—including all sub-ranges or values therebetween. In embodiments, the axial length of the hot zone may be ≥3 cm and ≤50 cm, ≥3 cm and ≤40 cm, ≥3 cm and ≤30 cm, ≥3 cm and ≤20 cm, ≥3 cm and ≤10 cm, ≥10 cm and ≤50 cm, ≥10 cm and ≤40 cm, ≥10 cm and ≤30 cm, ≥10 cm and ≤20 cm, ≥20 cm and ≤50 cm, ≥20 cm and ≤40 cm, ≥20 cm and ≤30 cm, ≥30 cm and ≤50 cm, ≥30 cm and ≤40 cm, or ≥40 cm and ≤50 cm. In embodiments, the axial length of the hot zone may be ≥3 cm, ≥5 cm, ≥10 cm, ≥15 cm, ≥20 cm, ≥25 cm, ≥30 cm, ≥35 cm, ≥40 cm, ≥45 cm, or greater. In embodiments, the axial length of the hot zone may be ≤50 cm, ≤45 cm, ≤40 cm, ≤35 cm, ≤30 cm, ≤25 cm, ≤20 cm, ≤15 cm, ≤10 cm, ≤5 cm, or less.

The drawing system 300 may further include a pressure control system 310. The pressure control system 310 may be coupled to and configured for pressuring the interior cavities of the outer tube 210, the inner tubes 220, and/or the nested tubes 230 (if present) of the hollow-core preform 200. The pressure control system 310 may include any or all of a pressure sensor, a vacuum system, a gas pressure source or gas supply, and/or a controller for monitoring the pressure(s) within the various cavities mentioned above and using vacuum and/or gas pressure to maintain the pressure(s) at a desired value(s). In embodiments, the pressure control system 310 may include a manifold connected to the gas pressure source or gas supply (not shown) for supplying gas to the hollow-core preform 200. The pressure(s) within the cavities mentioned above may at least in part determine the dimensions, such as diameters and thicknesses, of the outer cladding 110, the capillaries 120, and/or the nested capillaries 130 of the hollow-core optical fiber 100, as will be discussed in more detail below.

Referring again to FIG. 3, the drawing system 300 may further include a cooling chamber 312 to cool the hollow-core optical fiber 100. In embodiments, the drawing system 300 may further include a non-contact sensor 314 for measuring the dimension, e.g., diameter of the outer surface 112 of the outer cladding 110. In embodiments, the drawing system 300 may further include a coating apparatus 316 for applying and/or curing one or more coatings over the outer cladding 110.

The drawing system 300 may further include a tension assembly 318, such as tractor, for applying a draw tension to draw the hollow-core optical fiber 100 from the hollow-core preform 200. The draw tension may be controlled via a control apparatus 320 to at least in part maintain the dimension of the hollow-core optical fiber 100 at a predetermined set point. In some embodiments, the drawing system 300 may further include a winder 322 for winding the hollow-core optical fiber 100 onto a storage spool 324.

### Improving Process Stability

As discussed above, scale-up manufacturing of the hollow-core optical fiber may be achieved by, for example, increasing the size of the hollow-core preform while still achieving the same or similar target microstructures of the hollow-core optical fiber. Previous solutions to scale-up of hollow-core optical fibers follow the conventional concept of increasing the starting preform diameter to continuously draw longer lengths of fibers regardless of process conditions during the draw. However, since drawing a hollow-core optical fiber requires a need for precise dimensions within the fiber microstructure, the conventional methodology might not be suitable since the fiber dimensions obtained can deviate significantly from target dimensions during process scale-up.

The present disclosure is directed to scale-up methodologies that enable scaling of the hollow-core optical fiber drawing process while consistently achieving the target fiber microstructure dimensions, such as outer diameter (OD_{cap}) of drawn capillaries 120 and other drawn capillary 120 dimensions, during large volume manufacturing. To further limit any variation in the dimensions of the hollow-core optical fiber that may be affected due to changes in process conditions, the process parameters may be selected such that variations in fiber dimensions, such as capillary dimensions, due to process induced perturbations, e.g., inherent fluctuations in the core pressure P_{core}, may be limited such that longer length fibers with target dimensions of the microstructures may be achieved. The methods disclosed herein provide guidelines for scale-up of processes for drawing hollow-core optical fibers that can reduce size-variation in capillary dimensions in the drawn hollow-core fiber microstructure and that can deliver longer lengths of the hollow-core optical fiber with target fiber microstructure dimensions. This precise control of the capillary dimensions can be achieved through a combination of (a) incoming preform dimensions; (b) operating draw-down ratio; (c) fiber draw stress and/or draw tension; and (d) the target capillary thickness and size (i.e., drawn capillary OD) within the target fiber microstructure.

The methods disclosed herein include a set of scaling laws relating operable process conditions and hollow-fiber preform parameters needed to achieve a target fiber microstructure that can withstand the impact of slight perturbations in applied gas pressure within the outer cladding, which slight perturbations may be inherent to the fiber drawing process. Given a set furnace configuration, the methods disclosed herein provide scaling law relationships for the steady-state response of the outer diameter OD_{cap} of drawn capillaries 120 to the applied gas pressure variation within the outer cladding 110 as a function of the draw tension, draw stress, draw down ratio, target capillary thickness, target capillary size (OD_{cap}), or combinations thereof.

The scaling law relationships disclosed herein are suitable for drawing hollow-core optical fiber while precisely targeting fixed fiber and microstructure dimensions. In particular, the disclosed scaling law relationships describe how the incoming size of the hollow-core preform adversely affects the core gas pressure sensitivity of steady-state capillary dimensions (e.g., OD_{cap}) in the drawn hollow-core optical fiber and how tuning solely the draw stress, the draw tension, the draw-down ratio, or combinations of these can enable the target capillary dimensions to be achieved with reduced or minimal sensitivity to changes in core gas pressure. Specifically, longer lengths of hollow-core optical fiber can be obtained by increasing the incoming preform diameter and simultaneously increasing the operating draw stress (by increasing draw tension), draw down ratio, or both according to the scale-up relationships herein, which leads to a more consistent capillary OD_{cap} with reduced variation upon fluctuation of core gas pressure.

Referring again to FIG. 2B, development of the scaling law relationships disclosed herein are based on a hollow-core preform 200 having the outer tube 210 and six inner tubes 220 attached to the inner surface 211 of the outer tube 210. The inner tubes 220 are spaced apart from one another and distributed evenly and symmetrically within the outer tube 210 in the angular direction (i.e., +/−theta (Θ) direction of the coordinate axis in FIG. 2B). While drawing this hollow-core preform 200 in a typical furnace designed for fiber production, the objective of the modeling is to achieve the same microstructure arrangement in the drawn hollow-core optical fiber 100 (i.e., drawn hollow-core optical fiber 200 comprising the outer cladding 110 and six drawn capillaries 120 symmetrically spaced apart within the outer cladding 110) with target dimensions (e.g., OD_{cap}, capillary thickness t_{cap}, etc.). The target dimensions of both the outer cladding 110 and the drawn capillaries 120 are susceptible to any slight variation in applied gas pressure within outer cladding 110. The methods disclosed herein focus on analyzing the gas pressure sensitivity of steady-state dimensions of drawn capillaries 120, such as OD_{cap}. The underlying methodology in estimating steady-state response of the cladding dimensions, such as outer diameter and thickness of outer cladding 110, to variations in applied gas pressure can be found in co-pending U.S. Patent Application No. 63/683,461, filed Aug. 15, 2024, and entitled “HOLLOW-CORE OPTICAL FIBERS AND METHODS FOR PRODUCING THE SAME”, the entire contents of which are incorporated herein by reference.

Here, we disclose the governing scaling laws that relate the steady-state dimensions (i.e., OD_{cap}) of the drawn capillaries 120 with the applied gas pressure variation while targeting process scale-up conditions. Additionally, the modeling herein is based on a fixed furnace configuration that has a temperature profile evolving via a Gaussian shape: (1) length of furnace L_{f}=6.5 cm; (2) the location of the peak temperature within the furnace (zₘₐₓ) is equal to 4 cm, which is measured from the top of the furnace; and (3) the standard deviation of the Gaussian temperature profile is equal to 6 cm. The same furnace configuration is assumed for all modeling conducted in the present disclosure. The fundamental relationships (e.g., proportional, inverse, exponential, etc.) between variables presented herein are generally independent of the furnace configuration, and different furnace configurations can be accounted for by adjustments in the various constants. Different constants can be developed for alternative furnace configurations according to the modeling methods disclosed herein. The outer cladding 110 and the drawn capillaries 120 may be silica glass with or without dopants.

For the fixed furnace configuration, the sensitivity of the capillary dimensions (e.g., OD_{cap}) within the drawn hollow-core optical fiber is evaluated to variation in gas pressure within the core (i.e., interior cavity 215 of hollow core preform 200). During fiber draw, a pressure P core is applied to the core. Ideally, P_{core} is a constant throughout the draw process. In practice, however, variations ΔP_{core} in P_{core} occur. The variation ΔP_{core} in gas pressure in the core results in a variation in the gas pressure within the inner tubes 220, which can lead to a variation ΔOD_{cap} in outer diameter OD_{cap} of drawn capillaries 120. Preferably during draw of hollow-core fiber 100 from hollow-core preform 200, pressure is applied independently to hollow section 240 and each of inner tubes 220 of the hollow-core preform 200. A pressure P_{core} is applied to hollow section 240, which influences the pressure in the hollow core 140 of the hollow-core optical fiber 100 during draw. A pressure P_{capillary} is applied to inner tubes 220, which influences the pressure in drawn capillaries 120 during draw. Typically, but not necessarily, the pressure P_{capillary} is the same for each of the inner tubes 220. Draw conditions are set such that the pressure P_{core} and the pressure P_{capillary} differ. An excess pressure P_{excess}=P_{capillary}−P_{core} can be defined. Control of the excess pressure P_{excess} allows for control of the outer diameter OD_{cap} and thickness t_{cap} of drawn capillaries 120. Ideally, P_{excess} remains constant during draw to maintain high uniformity of OD_{cap} and the thickness t_{cap} of drawn capillaries 120 over extended lengths of the hollow-core optical fiber 100. In practice, P_{excess} fluctuates during draw. Variations ΔP_{excess} in the excess pressure P_{excess} contribute to the variations ΔOD_{cap} of drawn capillaries 120. In the disclosure that follows, modeled relationships between the variations ΔOD_{cap} and the variations ΔP_{excess} are described for various process conditions and strategies for mitigating the effects of changes in P_{excess} on OD_{cap} are presented. For purposes of the present disclosure, the variation ΔOD_{cap} is referred to as the “sensitivity” of OD_{cap}.

The relationships herein are developed for hollow-core preforms 200 having inner tubes 220 that are sealed at both ends. With both ends of the inner tubes 220 being sealed, the volume of gas within each of the inner tubes 220 during the drawing process is fixed. Thus, the pressure within each of the inner tubes 220 (P_{capillary}) is fixed at a given temperature for the inner tubes 220 sealed at both ends. The core gas pressure P_{core} can be determined at the upper end 204 of the hollow-core preform 200. Gas is applied to the upper end of the hollow-core preform 200 and the flow rate of the gas into the interior cavity 215 of the hollow-core preform 200 is measured. The pressure P_{core} in the interior cavity 215 of the hollow-core preform 200 can be estimated from the gas flow rate based on the Hagen-Poiseuille flow equation, which relates pressure drop across a finite length of a cylinder carrying a fluid at constant flow rate. Once the gas flow is delivered into the upper end 204 of the hollow-core preform 200, gas flow quickly equilibrates axially, and thus, the pressure P_{core} is assumed to be constant in the axial direction. Any change in cross-sectional dimension/area does not impact the pressure P_{core} in the interior cavity 215. As previously discussed, the sensitivity in drawn capillary dimensions (e.g., ΔOD_{cap}) is a manifestation of the fact that the pressure difference across capillary interface (ΔP_{excess}=P_{capillary}−P_{core}) is what that controls the expansion/contraction of the capillary, and any slight variation in P_{core} will translate to the said pressure difference ΔP_{excess}.

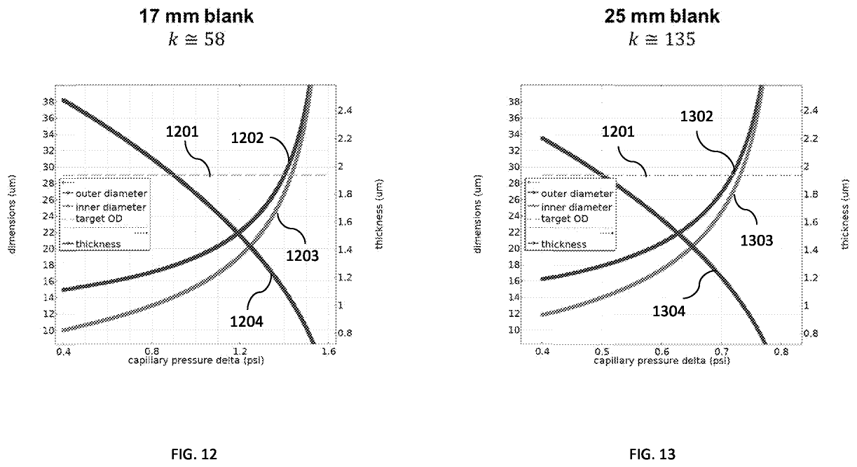

Referring now to FIG. 12, the effects of ΔP_{excess} on drawn capillary dimensions are graphically depicted. For FIG. 12, drawing a hollow-core preform 200 having an outer diameter of the outer tube 210 equal to 17 mm is modeled at different values of ΔP_{excess} at constant draw tension τ of 250 g. FIG. 12 shows the drawn capillary dimensions—outer diameter OD_{cap} 1202, inner diameter ID_{cap} 1203, and capillary wall thickness 1204—as a function of ΔP_{excess} for drawing the hollow-core preform having outer tube outer diameter of 17 mm. The target OD_{cap} is indicated in FIG. 12 with reference number 1201. As shown in FIG. 12, increasing the ΔP_{excess} at constant draw tension increases the OD_{cap} and ID_{cap} and decreases the thickness for the drawn capillaries. The slope of the sensitivity curve of OD_{cap} as a function of ΔP_{excess} (κ=ΔOD_{cap}/ΔP_{excess}) for drawing the hollow-core preform 200 having an outer tube outer diameter of 17 mm is calculated to be 58 (μm/psi).

Changing the size of the preform changes the sensitivity of the capillary dimensions to changes in ΔP_{excess}. Referring now to FIG. 13, drawing a hollow-core preform 200 having an outer diameter of the outer tube 210 equal to 25 mm is modeled at different values of ΔP_{excess} at constant draw tension τ of 250 g. The same furnace conditions are assumed. FIG. 13 shows the drawn capillary dimensions-outer diameter OD_{cap} 1302, inner diameter ID_{cap} 1303, and capillary wall thickness 1304—as a function of ΔP_{excess} for drawing the hollow-core preform having outer tube outer diameter of 25 mm. The target OD_{cap} is indicated in FIG. 13 with reference number 1201. As shown in FIG. 13, increasing the size of the hollow-core preform 200 from 17 mm to 25 mm (outer tube 210 outer diameter) increases the slope of the sensitivity curve of OD_{cap} as a function of ΔP_{excess} (κ=ΔOD_{cap}/ΔP_{excess}), which is calculated to be 135 (μm/psi) for hollow-core preform having outer tube outer diameter of 25 mm.

In a first set of exemplary modeled process conditions, the same dimensions of the internal microstructure of the hollow-core optical fiber are targeted (i.e., same outer diameter OD_{cap} and inner diameter ID_{cap} of the drawn capillaries 120). The target OD_{cap} is equal to 26.0 μm, and the target ID_{cap} is equal to 24.923 μm. The target dimensions of the outer cladding are also maintained constant at OD_{cladding}=180 μm and ID_{cladding}=105 μm. Hollow-core preforms of different sizes are modeled, but the starting aspect ratio of the hollow-core preform are maintained constant for all preform sizes, i.e., the process is scaled-up proportionally from the smallest hollow-core preform to the largest hollow-core preform. The draw speed is maintained constant. Table 1 provides the operating process conditions and hollow-core preform dimensions for drawing a hollow-core optical fiber with fixed outer cladding dimensions and capillary dimensions, while simultaneously also scaling-up the hollow-core preform size to obtain greater yields of the hollow-core optical fiber.

TABLE 1
Operating process conditions and hollow-core preform dimensions for drawing a hollow-
core optical fiber with fixed outer cladding dimensions and capillary dimensions.

| | | Outer Cladding Dimensions | | | | Capillary Dimensions | | | |
|---|---|---|---|---|---|---|---|---|---|
| | Draw | Starting | | | | Starting | | Final | Final |
| Feed | speed, | OD | Starting | Final OD | Final ID | OD | Starting | OD | ID |
| speed, U_{f} | U_{d} | (mm) | ID (mm) | (μm) | (μm) | (mm) | ID (mm) | (μm) | (μm) |
| (mm/min) | (m/min) | preform | preform | OD_{cladding} | ID_{cladding} | preform | preform | OD_{cap} | ID_{cap} |
| 2.28 | 24 | 17.0 | 8.0 | 180.0 | 105.0 | 1.14 | 0.85 | 26.0 | 24.923 |
| 1.054272 | 24 | 25.0 | 11.7647 | 180.0 | 105.0 | 1.6765 | 1.25 | 26.0 | 24.923 |
| 0.468565 | 24 | 37.5 | 17.6471 | 180.0 | 105.0 | 2.5147 | 1.875 | 26.0 | 24.923 |
| 0.263568 | 24 | 50.0 | 23.5294 | 180.0 | 105.0 | 3.3529 | 2.5 | 26.0 | 24.923 |

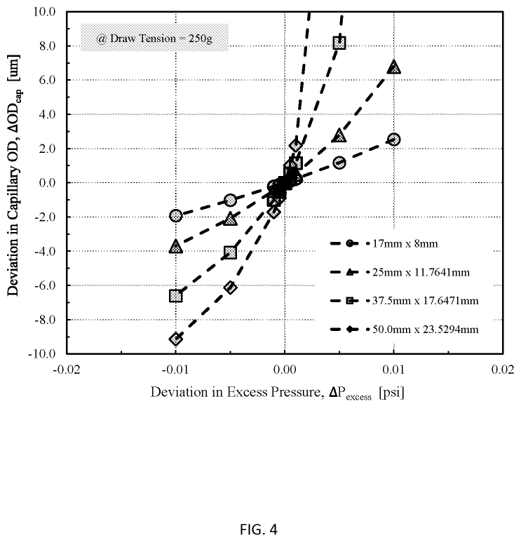

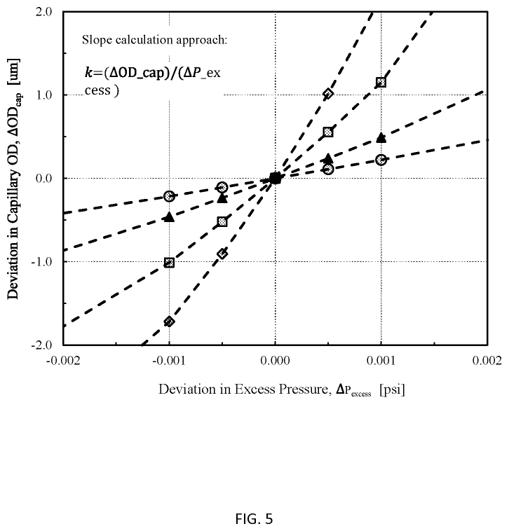

For each modeling simulation, the steady-state sensitivity ΔOD_{cap} was calculated and plotted as a function of ΔP_{excess}. Referring now to FIG. 4, the calculated deviation ΔOD_{cap} in the drawn capillary OD_{cap} is plotted as a function of ΔP_{excess} for each of the four hollow-core preform scale-up conditions listed in Table 1. A fixed operating draw tension (τ=250 g) was assumed. As shown in FIG. 4, the sensitivity ΔOD_{cap} of capillary OD increases sharply with increasing size of the hollow-core preform when producing hollow-core optical fibers with the same target microstructure. This sharp difference in the sensitivity of the capillary OD is mathematically quantified by calculating the slope (κ=ΔOD_{cap}/ΔP_{excess}) of the sensitivity curve at ΔP_{excess}=0. A greater slope indicates the capillary OD being more sensitive to variations in the excess pressure. Referring now to FIG. 5, the plot of the deviation in OD_{cap} as a function of ΔP_{excess} of FIG. 4 is zoomed in around ΔP_{excess}=0 for calculation of the slope (κ=ΔOD_{cap}/ΔP_{excess}) at ΔP_{excess}=0.

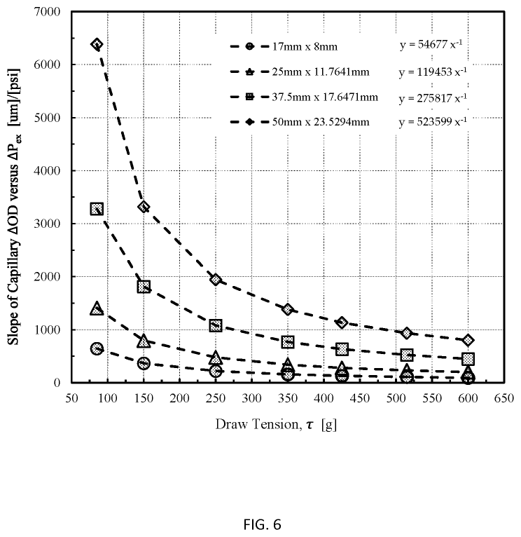

Additional simulations using the conditions listed in Table 1 were completed over a range of draw tension to assess the effect of draw tension on the sensitivity ΔOD_{cap}. Referring now to FIG. 6, the slope κ of the sensitivity ΔOD_{cap} with respect to ΔP_{excess} as a function operating draw tension is graphically depicted for each of the four conditions listed in Table 1. As shown in FIG. 6, process scale-up (via increasing dimensions of the hollow-core preform) has an adverse effect on the drawn capillary OD sensitivity since: (i) increasing the size of the hollow-core preform worsens the capillary OD sensitivity (i.e., makes OD_{cap} more sensitive to changes in P_{excess}); and (ii) achieving the same capillary OD sensitivity for larger-size hollow-core preforms compared to smaller-size hollow-core preforms requires a higher draw tension. FIG. 6 illustrates that increasing draw tension when drawing hollow-core optical fiber from a hollow-core preform can aid in controlling the capillary OD sensitivity. As indicated in FIG. 6, the slope of capillary OD sensitivity with respect to ΔP_{excess} can be inversely correlated with the draw tension (t). The following Equation 1 (EQU. 1) provides a scale-up relationship that relates the sensitivity ΔOD_{cap} to the draw tension (t).

ΔOD_{cap}=ΔP_{excess}×A×54677×τ⁻¹ EQU. 1

In EQU. 1, 54677 is an empirical constant derived from a fit of the modeled results shown in FIG. 4, τ is the draw tension in grams, and A is a dimensionless scaling factor that correlates with the ratio of starting cross-sectional area of the outer cladding as defined in Table 2. Using the data in Table 2, the scaling factor A can be calculated by the following Equation 2 (EQU. 2), where OD_{preform} and ID_{preform} are in units of mm.

$$A = \frac{{OD}_{p r e f o r m}^{2} - {ID}_{p r e f o r m}^{2}}{225} \qquad EQU . 2$$

In EQU. 2, OD_{preform} is the outer diameter of the outer tube of the hollow-core preform and ID_{preform} is the inner diameter of the outer tube of the hollow-core preform. EQU. 1 is valid for any draw down ratio β=ln(U_{d}/U_{f}).

TABLE 2
Tabulated data providing the increase in scaling factor
A with increasing incoming preform thickness.

| Starting | | Starting | Cross- | | |
|---|---|---|---|---|---|
| Outer | Starting | Outer | Sectional | | |
| Tube | Outer | Tube | Area of Outer | SCALING | Empirical |
| OD | Tube ID | Aspect | Tube of | FACTOR, | Constant, |
| (mm) | (mm) | Ratio | Preform (mm²) | A | C₁ |
| 17.0 | 8.0 | 0.4706 | 176.71 | 1.000 | 54677.0 |
| 25.0 | 11.7647 | 0.4706 | 382.17 | 2.163 | 118266.4 |
| 37.5 | 17.6471 | 0.4706 | 859.88 | 4.866 | 266058.3 |
| 50.0 | 23.5294 | 0.4706 | 1528.67 | 8.651 | 473010.7 |

In further embodiments, the sensitivity ΔOD_{cap} satisfies the condition:

0.90×(ΔP_{excess}×A×54677×τ⁻¹)≤ΔOD_{cap}≤1.10×(ΔP_{excess}×A×54677×τ⁻¹) EQU. 1A

or the condition:

0.95×(ΔP_{excess}×A×54677×τ⁻¹)≤ΔOD_{cap}≤1.05×(ΔP_{excess}×A×54677×τ⁻¹) EQU. 1B.

EQU. 1 is optimized for a drawn hollow-core optical fiber with a microstructure having a target capillary wall thickness of 538.5 nm, a target OD_{cap} of 26.0 microns (μm), a target OD_{cladding} of 180 μm, and a target ID_{cladding} of 105 μm. The inverse relationship between draw tension and OD_{cap} sensitivity, however, is independent of target microstructure. Thus, EQU. 1 can be adapted to other microstructure sizes and target dimensions through adjustment of the constant in EQU. 1. EQU. 1 can accordingly be generalized as follows:

ΔOD_{cap}=ΔP_{excess}×C₁×τ⁻¹ EQU. 1C.
where C₁ is an empirical constant, corresponding to the slope of a plot of ΔOD_{cap} as a function of ΔP_{excess} at ΔP_{excess}=0, that can be determined as illustrated in FIGS. 3 and 4 through experimentation or modeling. Calculated values of C₁ for different preform sizes are provided in Table 2. In further embodiments, the sensitivity ΔOD_{cap} satisfies:

0.90×(ΔP_{excess}×C₁×τ⁻¹)≤ΔOD_{cap}≤1.10×(ΔP_{excess}×C₁×τ⁻¹) EQU. 1D

or the condition:

0.95×(ΔP_{excess}×C₁×τ⁻¹)≤ΔOD_{cap}≤1.05×(ΔP_{excess}×C₁×τ⁻¹) EQU. 1E.

A method of making the hollow-core optical fiber can be based on any of the relationships in Equations 1, 1A, 1B, 1C, 1D, or 1E. In embodiments, a method of producing a hollow-core optical fiber comprises feeding a hollow-core preform into a draw furnace at a preform feed rate Uₚ in mm/min, wherein the hollow-core preform comprises an outer tube and a plurality of inner tubes disposed within the outer tube, wherein the outer tube has an outer diameter OD_{preform} and an inner diameter ID_{preform}. The method further includes heating the hollow-core preform in the draw furnace and drawing a hollow-core optical fiber from the hollow-core preform. The hollow-core optical fiber may be drawn at a fiber draw speed U_{d} in mm/min, a draw tension τ in grams, a core pressure P_{core} in a hollow-core of the hollow-core preform, and a capillary pressure P_{cap} in the plurality of inner tubes, thereby elongating the outer tube and the plurality of inner tubes of the hollow-core preform to produce the hollow-core optical fiber having an outer cladding, a plurality of drawn capillaries disposed within the outer cladding, and an interior cavity. The plurality of drawn capillaries of the hollow-core optical fiber may have an outer diameter OD_{cap} (in μm), and an excess pressure P_{excess} during the draw is equal to a difference between the core pressure P_{core} and the capillary pressure P_{cap}. The drawn capillary outer diameter sensitivity ΔOD_{cap} (in μm), which is defined as a variation in the outer diameter OD_{cap} of the plurality of drawn capillaries of the hollow-core optical fiber per change in the excess pressure ΔP_{excess}, may satisfy any of EQUS. 1, 1A, 1B, 1C, 1D, or 1E.

In embodiments, the plurality of drawn capillaries may have a target thickness t_{cap} of about 538.5 nm and a target outer diameter OD_{cap} of about 26.0 μm. In embodiments, the ΔP_{excess} may be from about 0.001 psig to about 0.02 psig. In embodiments, the outer cladding of the hollow-core optical fiber may have a cladding outer diameter OD_{cladding} of about 180 μm and a cladding inner diameter ID_{cladding} of about 105 μm.

The relationships of EQUS. 1, 1A, 1B, 1C, 1D, 1E, and others disclosed herein (see below), are particularly adapted to anti-resonant hollow-core optical fibers. Anti-resonant hollow core optical fibers rely upon anti-resonance between the core and the cladding to confine the fundamental mode electromagnetic radiation within the core and to prevent leakage of the fundamental mode into the cladding elements. With anti-resonant hollow-core optical fibers, the central hollow core is surrounded by cladding elements configured to confine the fundamental mode by anti-resonance. The anti-resonant cladding elements must meet specified thickness limitations (see below) to realize an anti-resonant effect. Anti-resonance occurs when reflection of the fundamental mode occurs at the interface between the core and the cladding elements. Coherent reflections from the thin walls of the cladding elements, analogous to a Fabry-Perot resonator, occurs to confine the fundamental mode in the core. The greater the anti-resonant effect of the cladding elements, the greater the confinement of the fundamental mode within the core, and thus the lower the confinement loss. Confinement of the fundamental mode in traditional solid core optical fibers occurs by total internal reflection and not by anti-resonance, so processing relationships known in the art for traditional solid core optical fibers are not transferable to anti-resonant hollow core optical fibers and new relationships, such as those disclosed herein, need to be developed.

In embodiments to achieve confinement by anti-resonance, the thickness t_{cap} of the drawn capillaries is within a range of from 250 nm to 1500 nm. For example, the thickness t_{cap} is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 500 nm to 850 nm, from 700 nm to 1400 nm, from 800 nm to 1300 nm, and so on). In embodiments, the thickness t_{cap} is within ±30%, ±25%, ±20%, ±15%, ±10%, or ±5% of a calculated thickness t as defined by the equation:

$$t = \frac{( 2 m - 1 ) λ}{4 \sqrt{{n}^{2} - 1}}$$

where m is an integer (e.g., 1, 2, 3, . . . ) corresponding to the order of antiresonance, A is the wavelength of the fundamental mode guided by the core, and n is the refractive index of the drawn capillaries.

The capillary OD sensitivity analysis can be further understood by individually analyzing how the change in desired target fiber microstructure dimensions (e.g., drawing varying fiber thickness, capillary thickness, or capillary size) will affect the resulting drawn capillary OD sensitivity. The effect of varying each of the target fiber thickness, target capillary thickness, and target capillary OD will now be discussed in further detail herein.

a. Impact of Drawn Fiber Size and/or Thickness

In a second set of exemplary modeled process conditions, the impact of the target size of the drawn hollow-core optical fiber on the sensitivity of OD_{cap} for constant dimensions of the capillaries is evaluated. In other words, the following analysis explores whether it is preferable in terms of OD_{cap} sensitivity to draw a thicker or a thinner hollow-core optical fiber with the exact same target capillary dimensions. In this second set of exemplary modeled process conditions, the same dimensions of the internal microstructure of the hollow-core optical fiber are targeted (i.e., same OD_{cap} and ID_{cap}). The target capillary dimensions are maintained constant at ID_{cap}=24.923 μm and OD_{cap}=26.0 μm. The target inner diameter of the outer cladding (ID_{cladding}) is maintained constant at ID_{cladding}=105 μm. The target outer diameter of the outer cladding (OD_{cladding}) is varied from OD_{cladding}=180 μm to OD_{cladding}=220 μm. The effect of the change in OD_{cladding} is investigated at fixed draw-down ratio and by varying the draw-down ratio. The draw-down ratio β is defined by the following Equation 3 (EQU. 3).

β=ln(U_{draw}/U_{feed}) EQU. 3

In EQU. 3, U_{feed} is the operating feed speed during the draw process, and U_{draw} is the operating draw speed during the draw process. The objective of the modeling is to achieve the above-mentioned microstructure dimensions of the hollow-core optical fiber regardless of the process conditions or hollow-core preform scale-up parameters used. For fixed draw-down ratio, the draw process is modeled using the process scale-up conditions previously provided in Table 1 to draw a hollow-core optical fiber having a microstructure with a cladding outer diameter OD_{cladding}=220 μm. The operating conditions, hollow-core preform size, and microstructure dimensions for the modeling at constant draw-down ratio are provided in Table 3.

TABLE 3
Operating process conditions and hollow-core preform dimensions for modeling
of draw process for a hollow-core optical fiber with OD_{cladding} = 220
μm while keeping the same process speeds to maintain a fixed draw-down ratio β.

| | | Outer Cladding Dimensions | | | | Capillary Dimensions | | | |
|---|---|---|---|---|---|---|---|---|---|
| | Draw | Starting | | | | Starting | | Final | Final |
| Feed | speed, | OD | Starting | Final OD | Final ID | OD | Starting | OD | ID |
| speed, U_{f} | U_{d} | (mm) | ID (mm) | (μm) | (μm) | (mm) | ID (mm) | (μm) | (μm) |
| (mm/min) | (m/min) | preform | preform | OD_{cladding} | ID_{cladding} | preform | preform | OD_{cap} | ID_{cap} |
| 2.280 | 24 | 21.3874 | 8.0 | 220.0 | 105.0 | 1.14 | 0.85 | 26.0 | 24.923 |
| 1.054 | 24 | 31.4521 | 11.7647 | 220.0 | 105.0 | 1.6765 | 1.25 | 26.0 | 24.923 |
| 0.4686 | 24 | 47.1781 | 17.6471 | 220.0 | 105.0 | 2.5147 | 1.875 | 26.0 | 24.923 |
| 0.2636 | 24 | 62.9041 | 23.5294 | 220.0 | 105.0 | 3.3529 | 2.5 | 26.0 | 24.923 |

The modeling is then repeated for varying the draw-down ratio β. The final OD_{cladding} was 220 μm, and the draw-down ratio is varied by maintaining a constant draw speed U_{draw}, while changing the feed speed U_{feed} to change the draw-down ratio. The target capillary dimensions are maintained constant at ID_{cap}=24.923 μm and OD_{cap}=26.0 μm. The target inner diameter of the outer cladding (ID_{cladding}) is also maintained constant at ID_{cladding}=105 μm. The process conditions, hollow-core preform dimensions, and target microstructure dimensions are provided in Table 4 for varying draw-down ratio β.

TABLE 4
Operating process conditions and hollow-core preform dimensions for modeling
of draw process for a hollow-core optical fiber with OD_{cladding} =
220 μm while freely varying the process speeds/draw-down ratio.

| | | Outer Cladding Dimensions | | | | Capillary Dimensions | | | |
|---|---|---|---|---|---|---|---|---|---|
| | Draw | Starting | | | | Starting | | Final | Final |
| Feed | speed, | OD | Starting | Final OD | Final ID | OD | Starting | OD | ID |
| speed, U_{f} | U_{d} | (mm) | ID (mm) | (μm) | (μm) | (mm) | ID (mm) | (μm) | (μm) |
| (mm/min) | (m/min) | preform | preform | OD_{cladding} | ID_{cladding} | preform | preform | OD_{cap} | ID_{cap} |
| 3.987 | 24 | 17.0 | 8.0 | 220.0 | 105.0 | 1.0259 | 0.85 | 26.0 | 24.923 |
| 1.843 | 24 | 25.0 | 11.7647 | 220.0 | 105.0 | 1.5087 | 1.25 | 26.0 | 24.923 |
| 0.8193 | 24 | 37.5 | 17.6471 | 220.0 | 105.0 | 2.2631 | 1.875 | 26.0 | 24.923 |
| 0.4609 | 24 | 50.0 | 23.5294 | 220.0 | 105.0 | 3.0175 | 2.5 | 26.0 | 24.923 |

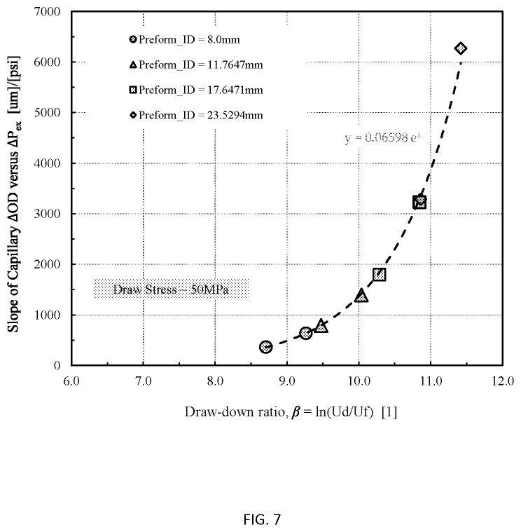

For each set of operating conditions, the steady-state sensitivity ΔOD_{cap} and slope κ of the sensitivity ΔOD_{cap} with respect to ΔP_{excess} were calculated and plotted as a function of draw-down ratio β and also as a function of draw stress. Referring now to FIG. 7, the slope κ of the sensitivity ΔOD_{cap} as a function of draw-down ratio for drawing the hollow-core optical fiber at a fixed draw stress of 50 MPa is graphically depicted for the conditions listed in Tables 3 and 4. As shown in FIG. 7, the slope κ of the sensitivity ΔOD_{cap} (units of μm/psi) with respect to ΔP_{excess} can be directly correlated with the draw-down ratio via an exponential relationship. It was also found that the pre-exponential factor (units of μm/psi) is inherently dependent on the draw stress σ (units of MPa) on the hollow-core optical fiber during the drawing process.

The draw stress σ is related to the draw tension of the drawing process according to the relationship provided in Equation 4 (EQU. 4).

$$σ = \frac{4}{π} \times \frac{τ}{( {OD}_{cladding}^{2} - {ID}_{cladding}^{2}} ) \qquad EQU . 4$$

In EQU. 4, σ is the draw stress in MPa, τ is the draw tension in grams applied to the hollow-core optical fiber during the draw process, OD_{cladding} is the outer diameter in μm of the outer cladding of the hollow-core optical fiber drawn, and ID_{cladding} is the inner diameter in μm of the outer cladding of the hollow-core optical fiber drawn.

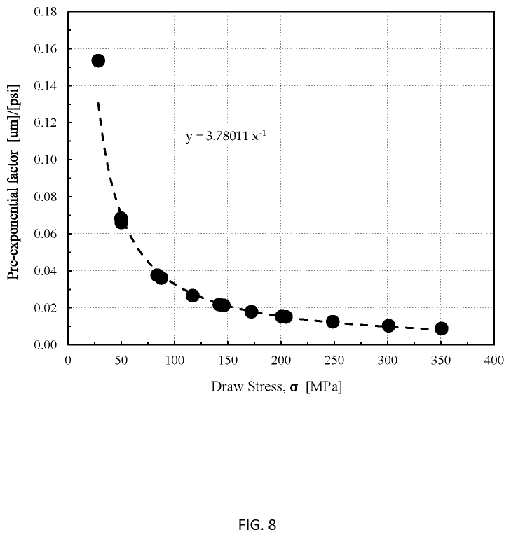

Referring now to FIG. 8, the pre-exponential factor (μm/psi) from the fitted exponential expression derived from FIG. 7 as a function of draw stress σ (MPa) is graphically depicted. As shown in FIG. 8, the pre-exponential factor is inversely related to the draw stress σ. Combining the correlations developed from FIGS. 7 and 8, a universal scale-up relationship is developed that correlates the slope κ of the sensitivity ΔOD_{cap} with respect to ΔP_{excess}) to the draw-down ratio and draw stress, which is provided in Equation 5 (EQU. 5).

$$κ = \frac{Δ {OD}_{cap}}{Δ {P}_{excess}} = 3.78011 \times \frac{1}{σ} \times \frac{{U}_{draw}}{{U}_{feed}} \qquad EQU . 5$$

In EQU. 5, σ is the draw stress in MPa, U_{draw} is the draw speed in mm/min, and U_{feed} is the preform feed speed in mm/min. In EQU. 5, 3.78011 is an empirical constant derived from a fit of the modeled results in FIGS. 7 and 8. EQU. 5 can be rearranged to solve for the sensitivity ΔOD_{cap}, as shown in EQU. 5A.

$$Δ {OD}_{cap} = Δ {P}_{excess} \times 3.78011 \times \frac{1}{σ} \times \frac{{U}_{draw}}{{U}_{feed}} \qquad EQU . 5 A$$

In embodiments, the sensitivity ΔOD_{cap} satisfies the following condition:

$$0.9 \times ( Δ {P}_{excess} \times 3.78011 \times \frac{1}{σ} \times \frac{{U}_{draw}}{{U}_{feed}} ) \leq Δ {OD}_{cap} \leq 1.1 \times ( Δ {P}_{excess} \times 3.78011 \times \frac{1}{σ} \times \frac{{U}_{draw}}{{U}_{feed}} ) \qquad EQU . 5 B$$

or the condition:

$$0.95 \times ( Δ {P}_{excess} \times 3.78011 \times \frac{1}{σ} \times \frac{{U}_{draw}}{{U}_{feed}} ) \leq Δ {OD}_{cap} \leq 1.05 \times ( Δ {P}_{excess} \times 3.78011 \times \frac{1}{σ} \times \frac{{U}_{draw}}{{U}_{feed}} ) \qquad EQU . 5 C .$$

EQU. 5 is optimized for a drawn hollow-core optical fiber with a microstructure having a target capillary wall thickness of 538.5 nm, a target OD_{cap} of 26.0 microns μm, a target ID_{cap} of 24.923 μm, and a target ID_{cladding} of 105 μm. EQU. 5 applies for any target OD_{cladding}, such as but not limited to an OD_{cladding} of from 180 μm to 220 μm. The inverse relationship between sensitivity ΔOD_{cap} and draw stress and the direct relationship between sensitivity ΔOD_{cap} and U_{draw}/U_{feed}, however, are independent of target microstructure. Thus, EQUS. 5 and 5A can be adapted to other microstructure sizes and target dimensions through adjustment of the constant in EQUS. 5 and 5A. EQU. 5A can accordingly be generalized as follows in EQU. 5D:

$$Δ {OD}_{cap} = Δ {P}_{excess} \times {C}_{2} \times \frac{1}{σ} \times \frac{{U}_{draw}}{{U}_{feed}} \qquad EQU . 5 D$$

In EQU. 5D, C₂ is an empirical constant that can be determined as illustrated in FIGS. 7 and 8 through experimentation or modeling. In further embodiments, the sensitivity ΔOD_{cap} satisfies the following condition:

$$0.9 \times ( Δ {P}_{excess} \times {C}_{2} \times \frac{1}{σ} \times \frac{{U}_{draw}}{{U}_{feed}} ) \leq Δ {OD}_{cap} \leq 1.1 \times ( Δ {P}_{excess} \times {C}_{2} \times \frac{1}{σ} \times \frac{{U}_{draw}}{{U}_{feed}} ) \qquad EQU . 5 E$$

or the following condition:

$$0.95 \times ( Δ {P}_{excess} \times {C}_{2} \times \frac{1}{σ} \times \frac{{U}_{draw}}{{U}_{feed}} ) \leq Δ {OD}_{cap} \leq 1.05 \times ( Δ {P}_{excess} \times {C}_{2} \times \frac{1}{σ} \times \frac{{U}_{draw}}{{U}_{feed}} ) \qquad EQU . 5 F .$$

When the hollow-core optical fiber has a cladding outer diameter OD_{cladding} of 180 μm, EQU. 5A can be reduced to EQU. 1, and Equation 5D can be reduced to EQU. 1C.

A method of making the hollow-core optical fiber can be based on any of the relationships in EQUS. 5, 5A, 5B, 5C, 5D, 5E, or 5F. In embodiments, a method of producing a hollow-core optical fiber includes feeding a hollow-core preform into a draw furnace at a preform feed rate, wherein the hollow-core preform comprises an outer tube and a plurality of inner tubes disposed within the outer tube, wherein the outer tube has an outer diameter OD_{preform} and an inner diameter ID_{preform}. The method may further include heating the hollow-core preform in the draw furnace and drawing a hollow-core optical fiber from the hollow-core preform. The hollow-core optical fiber may be drawn from the hollow-core preform at a fiber draw rate, a draw stress, a draw tension τ, a core pressure P_{core} in a hollow-core of the hollow-core preform, and a capillary pressure P_{cap} in the plurality of inner tubes, thereby elongating the outer tube and the plurality of inner tubes of the hollow-core preform to produce the hollow-core optical fiber having an outer cladding, a plurality of drawn capillaries disposed within the outer cladding, and an interior cavity. The plurality of drawn capillaries of the hollow-core optical fiber have an outer diameter OD_{cap} (in μm) and an excess pressure P_{excess} is equal to a difference between the core pressure P_{core} and the capillary pressure P_{cap}. The drawn capillary outer diameter sensitivity ΔOD_{cap} (in μm), which is defined as a variation in the outer diameter OD_{cap} of the plurality of drawn capillaries of the hollow-core optical fiber per change in the excess pressure ΔP_{excess}, may satisfy any of Equations 5, 5A, 5B, 5C, 5D, 5E, or 5F.

In embodiments, the plurality of drawn capillaries may have a target thickness of about 538.5 nm and a target outer diameter OD_{cap} of about 26.0 μm. In embodiments, the ΔP_{excess} may be from about 0.001 psig to about 0.02 psig. In embodiments, the outer cladding of the hollow-core optical fiber may have a cladding inner diameter ID_{cladding} of about 105 μm. In embodiments, the outer cladding may have a cladding outer diameter OD_{cladding} of from about 150 μm to about 300 μm. In embodiments, the hollow-core optical fiber may have a cladding outer diameter OD_{cladding} of about 180 μm and the drawn capillary outer diameter sensitivity ΔOD_{cap} (in μm) may satisfy any of Equations 1, 1A, 1B, 1C, 1D, or 1E.

b. Impact of Drawn Capillary Thickness

In a third set of exemplary modeled process conditions, the effect of the drawn capillary thickness of the hollow-core optical fiber on the sensitivity of OD_{cap} is evaluated. In other words, the following analysis explores whether the target drawn capillary thickness has any effect on the OD_{cap} sensitivity. This is interesting since a hollow-core optical fiber microstructure is capable of optical transmission via multiple windows (which is a result of anti-resonance phenomena created by capillaries of varying thicknesses within the fiber microstructure). The following analysis uses the process conditions in Table 1 to draw a hollow-core optical fiber having a plurality of capillaries with a thickness t_{cap} of the capillaries that is double the thickness in Table 1 (i.e., t_{cap}=2×5368.5 nm=1077 nm). In the following modeling analysis, the target capillary OD is maintained constant at OD_{cap}=26.0 μm, the target inner diameter of the outer cladding (ID_{cladding}) is maintained constant at ID_{cladding}=105 μm, and the target outer diameter of the outer cladding (OD_{cladding}) is maintained constant at OD_{cladding}=180 μm. The draw speed is maintained constant at 24 mm/min. The operating conditions, dimensions of the hollow-core preform, and dimensions of the hollow-core optical fiber drawn therefrom are provided in Table 5.

TABLE 5
Operating process conditions, preform dimensions, and hollow-core optical fiber dimensions for
scale up of draw process for a fiber microstructure having a capillary thickness t_{cap} = 1077 nm.

| | | Outer Cladding Dimensions | | | | Capillary Dimensions | | | |
|---|---|---|---|---|---|---|---|---|---|
| | Draw | Starting | | | | Starting | | Final | Final |
| Feed | speed, | OD | Starting | Final OD | Final ID | OD | Starting | OD | ID |
| speed, U_{f} | U_{d} | (mm) | ID (mm) | (μm) | (μm) | (mm) | ID (mm) | (μm) | (μm) |
| (mm/min) | (m/min) | preform | preform | OD_{cladding} | ID_{cladding} | preform | preform | OD_{cap} | ID_{cap} |
| 2.28 | 24 | 17.0 | 8.0 | 180.0 | 105.0 | 1.14 | 0.4116 | 26.0 | 23.846 |
| 1.054272 | 24 | 25.0 | 11.7647 | 180.0 | 105.0 | 1.6765 | 0.6053 | 26.0 | 23.846 |
| 0.468565 | 24 | 37.5 | 17.6471 | 180.0 | 105.0 | 2.5147 | 0.9079 | 26.0 | 23.846 |
| 0.263568 | 24 | 50.0 | 23.5294 | 180.0 | 105.0 | 3.3529 | 1.2106 | 26.0 | 23.846 |

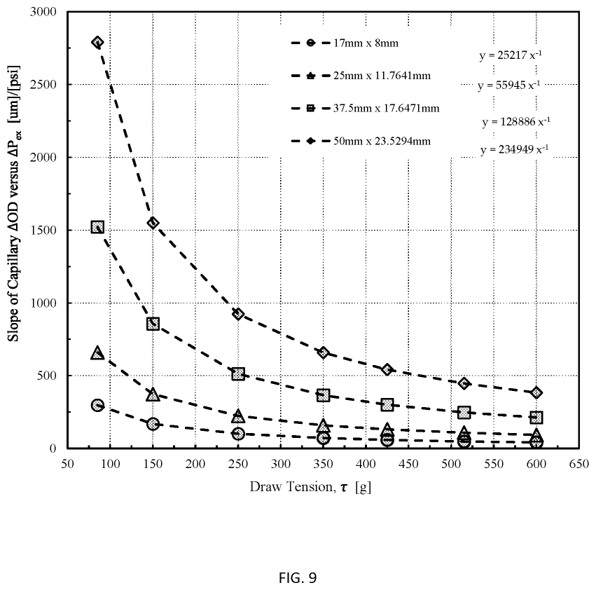

For each set of operating conditions, the steady-state sensitivity ΔOD_{cap} with respect to ΔP_{excess} were calculated and plotted as a function of draw tension. Referring now to FIG. 9, the slope κ of the sensitivity ΔOD_{cap} as a function of operating draw tension is graphically depicted for each of the 4 sizes of the hollow-core preforms in Table 5 for the hollow-core optical fibers having capillary thickness of 1077 nm. Upon comparing FIG. 9 with FIG. 6 (corresponding to drawing capillary with target capillary thickness of 538.5 nm under the same process conditions), it is apparent that the sensitivity ΔOD_{cap} is inversely proportional to drawn capillary thickness t_{cap} (i.e., the ΔOD_{cap} improves when drawing a thicker capillary). Therefore, from process stability point-of-view, drawing a thicker capillary (to target second-window of optical transmission) may reduce the sensitivity of the OD_{cap} to changes in excess pressure (ΔP_{excess}). Additionally, the scale-up relationship of EQU. 1, which relates capillary OD sensitivity (κ=ΔOD_{cap}/ΔP_{excess}) with draw tension can be roughly correlated with the target capillary thickness. For instance, similar to the scale-up relationship in FIG. 6 (labelled as “cap_1”), the scale-up relationship for FIG. 9 (labelled as “cap_2”) can be obtained via the following expressions in Equations 6 and 7 (EQU. 6 and EQU. 7).

$$[ {κ}_{cap \_ 1} \times {t}_{cap \_ 1} ] ∼ [ {κ}_{cap \_ 2} \times {t}_{cap \_ 2} ] \qquad EQU . 6$$

$${κ}_{cap \_ 2} \approx \frac{{t}_{cap \_ 1}}{{t}_{cap \_ 2}} \times {κ}_{cap \_ 1} = \frac{538.5}{{t}_{cap \_ 2}} \times [ A \times ( 54677 ) \times {τ}^{- 1} ] \qquad EQU . 7$$

In EQU. 6 and 7, κ_{cap_1} is the sensitivity ΔOD_{cap} with respect to ΔP_{excess} of a first hollow-core optical fiber having a first capillary thickness t_{cap_1} in nanometers (nm), and κ_{cap_2} is the sensitivity ΔOD_{cap} with respect to ΔP_{excess} of a second hollow-core optical fiber having a second capillary thickness t_{cap_2} in nm. In EQU. 7, the first hollow-core optical fiber is the optical fiber of Table 1 having t_{cap_1} equal to 538.5 nm. The relationship from EQU. 1 is substituted for κ_{cap_1}. In EQU. 7, τ is the draw tension in grams. The term κ_{cap_2} in EQU. 7 can be replaced by ΔOD_{cap}/ΔP_{excess} and rearranged to give Equation 8 (EQU. 8).

$$Δ {OD}_{cap} = Δ {P}_{excess} \times \frac{538.5}{{t}_{cap}} \times ( A \times 54677 \times {τ}^{- 1} ) \qquad EQU . 8$$

In EQU. 8, “cap_2” is shortened to just “cap” so that ΔOD_{cap} is the change in capillary outer diameter of the second hollow-core optical fiber and t_{cap} is the capillary thickness of the second hollow-core optical fiber. In EQU. 8, the constant 54677 is an empirical constant derived from a fit of the modeled results in FIG. 6. In embodiments, the sensitivity ΔOD_{cap} satisfies the following condition:

$$0.9 \times [ Δ {P}_{excess} \times \frac{538.5}{{t}_{cap}} \times ( A \times 54677 \times {τ}^{- 1} ) ] \leq Δ {OD}_{cap} \leq 1.1 \times [ Δ {P}_{excess} \times \frac{538.5}{{t}_{cap}} \times ( A \times 54677 \times {τ}^{- 1} ) ] \qquad EQU . 8 A$$

or the condition:

$$0.95 \times [ Δ {P}_{excess} \times \frac{538.5}{{t}_{cap}} \times ( A \times 54677 \times {τ}^{- 1} ) ] \leq Δ {OD}_{cap} \leq 1.05 \times [ Δ {P}_{excess} \times \frac{538.5}{{t}_{cap}} \times ( A \times 54677 \times {τ}^{- 1} ) ] \qquad EQU . 8 B .$$

EQU. 8 is optimized for a drawn hollow-core optical fiber with a microstructure having a target OD_{cap} of 26.0 μm, a target OD_{cladding} of 180 μm, and a target ID_{cladding} of 105 μm. However, the inverse relationship between sensitivity ΔOD_{cap} and capillary thickness t_{cap} and between sensitivity ΔOD_{cap} and draw tension τ are independent of the target microstructure. Thus, EQU. 8 can be adapted to apply to other microstructure sizes and target dimensions through adjustment of the constants in EQU. 8. EQU. 8 can accordingly be generalized as follows in EQU. 8C:

$$Δ {OD}_{cap} = Δ {P}_{excess} \times \frac{{C}_{3}}{{t}_{cap}} \times ( {C}_{1} \times {τ}^{- 1} ) \qquad EQU . 8 C$$

In EQU. 8C, C₁ is an empirical constant that can be determined as illustrated in FIG. 6 through experimentation or modeling. C₃ is a reference capillary thickness in nm (i.e., t_{cap_1} in EQU. 7). In further embodiments, the sensitivity ΔOD_{cap} satisfies the following condition:

$$0.9 \times [ Δ {P}_{excess} \times \frac{{C}_{3}}{{t}_{cap}} \times ( {C}_{1} \times {τ}^{- 1} ) ] \leq Δ {OD}_{cap} \leq 1.1 \times [ Δ {P}_{excess} \times \frac{{C}_{3}}{{t}_{cap}} \times ( {C}_{1} \times {τ}^{- 1} ) ] \qquad EQU . 8 D$$

or the condition:

$$0.95 \times [ Δ {P}_{excess} \times \frac{{C}_{3}}{{t}_{cap}} \times ( {C}_{1} \times {τ}^{- 1} ) ] \leq Δ {OD}_{cap} \leq 1.05 \times [ Δ {P}_{excess} \times \frac{{C}_{3}}{{t}_{cap}} \times ( {C}_{1} \times {τ}^{- 1} ) ] \qquad EQU . 8 E$$

EQU. 8 can be modified to apply to any target OD_{cladding} by substituting EQU. 5 for EQU. 1 in EQU. 8 to obtain the following EQU. 9, which applies for any capillary thickness and any OD_{cladding}.

$$Δ {OD}_{cap} = Δ {P}_{excess} \times \frac{538.5}{{t}_{cap}} \times ( 3.78011 \times \frac{1}{σ} \times \frac{{U}_{d}}{{U}_{p}} ) \qquad EQU . 9$$

In EQU. 9, σ is the draw stress in MPa as previously defined, U_{d} is the draw speed in mm/min, and Uₚ is the feed speed of the hollow-core preform in mm/min. In EQU. 9, the constant 3.78011 is an empirical constant derived from a fit of the modeled results in FIGS. 7 and 8. In embodiments, the sensitivity ΔOD_{cap} satisfies the following condition:

$$0.9 \times [ Δ {P}_{excess} \times \frac{538.5}{{t}_{cap}} \times ( 3.78011 \times \frac{1}{σ} \times \frac{{U}_{d}}{{U}_{p}} ) ] \leq Δ {OD}_{cap} \leq 1.1 \times [ Δ {P}_{excess} \times \frac{538.5}{{t}_{cap}} \times ( 3.78011 \times \frac{1}{σ} \times \frac{{U}_{d}}{{U}_{p}} ) ] \qquad EQU . 9 A$$

or the following condition:

$$0.95 \times [ Δ {P}_{excess} \times \frac{538.5}{{t}_{cap}} \times ( 3.78011 \times \frac{1}{σ} \times \frac{{U}_{d}}{{U}_{p}} ) ] \leq Δ {OD}_{cap} \leq 1.05 \times [ Δ {P}_{excess} \times \frac{538.5}{{t}_{cap}} \times ( 3.78011 \times \frac{1}{σ} \times \frac{{U}_{d}}{{U}_{p}} ) ] \qquad EQU . 9 B$$

EQU. 9 can be applied to estimate the OD_{cap} sensitivity of hollow-core optical fibers having a target OD_{cap} of 26.0 μm, an ID_{cladding} of 105 μm, and any capillary thickness and OD_{cladding}. As indicated herein, the inverse relationship between sensitivity ΔOD_{cap} and capillary thickness t_{cap} and between sensitivity ΔOD_{cap} and draw tension τ, however, are independent of the target microstructure. Thus, EQU. 9 can be adapted to apply to other microstructure sizes and target dimensions through adjustment of the constants in EQU. 9. EQU. 9 can accordingly be generalized as follows in EQU. 9C.

$$Δ {OD}_{cap} = Δ {P}_{excess} \times \frac{{C}_{3}}{{t}_{cap}} \times ( {C}_{2} \times \frac{1}{σ} \times \frac{{U}_{d}}{{U}_{p}} ) \qquad EQU . 9 C$$

In EQU. 9C, C₂ is an empirical constant that can be determined as illustrated in FIGS. 7 and 8 through experimentation or modeling. C₃ is a reference capillary thickness in nm (i.e., t_{cap_1} in EQU. 7). In embodiments, the sensitivity ΔOD_{cap} satisfies the following condition:

$$0.9 \times [ Δ {P}_{excess} \times \frac{{C}_{3}}{{t}_{cap}} \times ( {C}_{2} \times \frac{1}{σ} \times \frac{{U}_{d}}{{U}_{p}} ) ] \leq Δ {OD}_{cap} \leq 1.1 \times [ Δ {P}_{excess} \times \frac{{C}_{3}}{{t}_{cap}} \times ( {C}_{2} \times \frac{1}{σ} \times \frac{{U}_{d}}{{U}_{p}} ) ] \qquad EQU . 9 D$$

or the following condition:

$$0.95 \times [ Δ {P}_{excess} \times \frac{{C}_{3}}{{t}_{cap}} \times ( {C}_{2} \times \frac{1}{σ} \times \frac{{U}_{d}}{{U}_{p}} ) ] \leq Δ {OD}_{cap} \leq 1.05 \times [ Δ {P}_{excess} \times \frac{{C}_{3}}{{t}_{cap}} \times ( {C}_{2} \times \frac{1}{σ} \times \frac{{U}_{d}}{{U}_{p}} ) ] \qquad EQU . 9 E$$

A method of making the hollow-core optical fiber can be based on any of the relationships in Equations 8, 8A, 8B, 8C, 8D, 8E, 9, 9A, 9B, 9C, 9D, or 9E. In embodiments, the method of producing the hollow-core optical fiber can comprise feeding a hollow-core preform into a draw furnace at a preform feed rate, wherein the hollow-core preform comprises an outer tube and a plurality of inner tubes disposed within the outer tube, wherein the outer tube has an outer diameter OD_{preform} and an inner diameter ID_{preform}. The method may further include heating the hollow-core preform in the draw furnace and drawing a hollow-core optical fiber from the hollow-core preform. The hollow-core optical fiber may be drawn from the hollow-core preform at a fiber draw rate, a draw tension τ, a core pressure P_{core} in a hollow-core of the hollow-core preform, and a capillary pressure P_{cap} in the plurality of inner tubes, thereby elongating the outer tube and the plurality of inner tubes of the hollow-core preform to produce the hollow-core optical fiber having an outer cladding, a plurality of drawn capillaries disposed within the outer cladding, and an interior cavity. The plurality of drawn capillaries of the hollow-core optical fiber have an outer diameter OD_{cap} (in μm) and a thickness t_{cap} (in nm), and an excess pressure P_{excess} is equal to a difference between the core pressure P_{core} and the capillary pressure P_{cap}. The drawn capillary outer diameter sensitivity ΔOD_{cap} (in μm), which is defined as a variation in the outer diameter OD_{cap} of the plurality of drawn capillaries of the hollow-core optical fiber per change in the excess pressure ΔP_{excess}, may satisfy any of the relationships in Equations 9, 9A, 9B, 9C, 9E, or 9F.

In embodiments, the plurality of drawn capillaries may have a target outer diameter OD_{cap} of about 26.0 μm. In embodiments, the ΔP_{excess} may be from about 0.001 psig to about 0.02 psig. In embodiments, the hollow-core optical fiber may have a cladding inner diameter ID_{cladding} of about 105 μm. In embodiments, the outer cladding may have a cladding outer diameter OD_{cladding} of from about 150 μm to about 300 μm. In embodiments, the outer cladding may have a cladding outer diameter OD_{cladding} of about 180 μm and the drawn capillary outer diameter sensitivity ΔOD_{cap} (in μm) may any of Equations 8, 8A, 8B, 8C, 8D, or 8E. In embodiments, the plurality of drawn capillaries have a target thickness t_{cap} of 538.5 nm, and the drawn capillary outer diameter sensitivity ΔOD_{cap} (in μm) may the relationship in any of Equations 1, 1A, 1B, 1C, 1D, or 1E.

c. Impact of Drawn Capillary Size (OD_{cap})

In a fourth set of exemplary modeled process conditions, the effect of the drawn capillary size (i.e., target OD_{cap}) of the hollow-core optical fiber on the sensitivity ΔOD_{cap} with respect to ΔP_{excess} is evaluated. In other words, the following analysis explores the effects of the target drawn capillary size on the sensitivity ΔOD_{cap} with respect ΔP_{excess}. In this fourth set of exemplary modeled process conditions, hollow-core optical fibers are drawn while varying the OD_{cap} from 20.0 μm to 26.0 μm to 32.0 μm. The capillary thickness is maintained generally constant at 538.5 nm, the cladding outer diameter is constant at OD_{cladding}=180 μm, and the cladding inner diameter is constant at 105 μm. The draw speed is constant at 24 mm/min, and the draw-down ratio β is held constant. The operating conditions, hollow-core preform dimensions, and dimensions of the hollow-core optical fiber for OD_{cap}=26.0 μm are provided in Table 1. The operating conditions, hollow-core preform dimensions, and dimensions of the hollow-core optical fiber for OD_{cap}=20.0 μm and OD_{cap}=32.0 are provided in Tables 6 and 7, respectively.

TABLE 6
Operating process conditions, preform dimensions, and hollow-core optical fiber dimensions for scale-up
of draw process for a fiber microstructure having a capillary outer diameter OD_{cap} = 20.0 μm.

| | | Outer Cladding Dimensions | | | | Capillary Dimensions | | | |
|---|---|---|---|---|---|---|---|---|---|
| | Draw | Starting | | | | Starting | | Final | Final |
| Feed | speed, | OD | Starting | Final OD | Final ID | OD | Starting | OD | ID |
| speed, U_{f} | U_{d} | (mm) | ID (mm) | (μm) | (μm) | (mm) | ID (mm) | (μm) | (μm) |
| (mm/min) | (m/min) | preform | preform | OD_{cladding} | ID_{cladding} | preform | preform | OD_{cap} | ID_{cap} |
| 2.28 | 24 | 17.0 | 8.0 | 180.0 | 105.0 | 1.0788 | 0.85 | 20.0 | 18.923 |
| 1.054272 | 24 | 25.0 | 11.7647 | 180.0 | 105.0 | 1.5864 | 1.25 | 20.0 | 18.923 |
| 0.468565 | 24 | 37.5 | 17.6471 | 180.0 | 105.0 | 2.3797 | 1.875 | 20.0 | 18.923 |
| 0.263568 | 24 | 50.0 | 23.5294 | 180.0 | 105.0 | 3.1729 | 2.5 | 20.0 | 18.923 |

TABLE 7
Operating process conditions, preform dimensions, and hollow-core optical fiber dimensions for scale-up
of draw process for a fiber microstructure having a capillary outer diameter OD_{cap} = 32.0 μm.

| | | Outer Cladding Dimensions | | | | Capillary Dimensions | | | |
|---|---|---|---|---|---|---|---|---|---|
| | Draw | Starting | | | | Starting | | Final | Final |
| Feed | speed, | OD | Starting | Final OD | Final ID | OD | Starting | OD | ID |
| speed, U_{f} | U_{d} | (mm) | ID (mm) | (μm) | (μm) | (mm) | ID (mm) | (μm) | (μm) |
| (mm/min) | (m/min) | preform | preform | OD_{cladding} | ID_{cladding} | preform | preform | OD_{cap} | ID_{cap} |
| 2.28 | 24 | 17.0 | 8.0 | 180.0 | 105.0 | 1.1983 | 0.85 | 32.0 | 30.923 |
| 1.054272 | 24 | 25.0 | 11.7647 | 180.0 | 105.0 | 1.7622 | 1.25 | 32.0 | 30.923 |
| 0.468565 | 24 | 37.5 | 17.6471 | 180.0 | 105.0 | 2.6432 | 1.875 | 32.0 | 30.923 |
| 0.263568 | 24 | 50.0 | 23.5294 | 180.0 | 105.0 | 3.5243 | 2.5 | 32.0 | 30.923 |

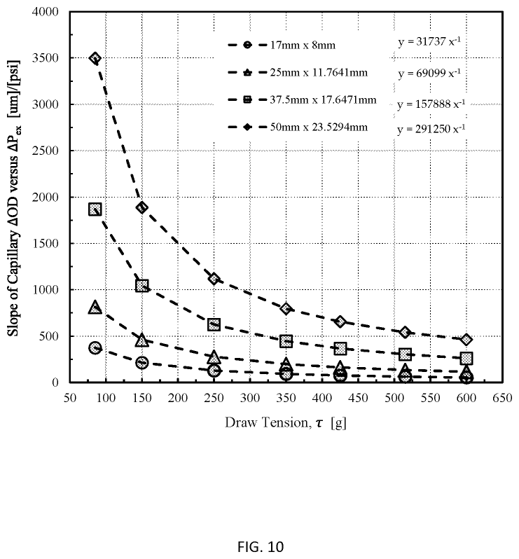

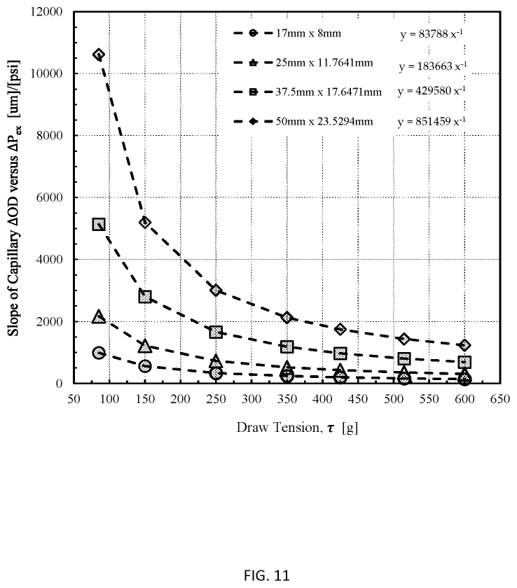

For each set of operating conditions, the steady-state sensitivity ΔOD_{cap} and slope κ of the sensitivity ΔOD_{cap} with respect to ΔP_{excess} were calculated and plotted as a function of draw tension. Referring now to FIG. 10, the slope κ of the sensitivity ΔOD_{cap} with respect to ΔP_{excess} as a function operating draw tension is graphically depicted for each of the 4 sizes of the hollow-core preforms in Table 6 for the hollow-core optical fibers having OD_{cap}=20.0 μm. FIG. 6 provides the slope κ of the sensitivity ΔOD_{cap} with respect to ΔP_{excess} as a function of draw tension for the operating conditions in Table 1 for the hollow-core optical fibers having OD_{cap}=26.0 μm. Referring now to FIG. 11, the slope κ of the sensitivity ΔOD_{cap} with respect to ΔP_{excess} as a function operating draw tension is graphically depicted for each of the 4 sizes of the hollow-core preforms in Table 7 for the hollow-core optical fibers having OD_{cap}=32.0 μm.

As shown through a comparison of FIGS. 6, 10, and 11, the slope κ of the sensitivity ΔOD_{cap} with respect to ΔP_{excess} worsens with increasing size of the drawn capillary. In other words, as the target OD_{cap} increases, the slope κ of the sensitivity ΔOD_{cap} with respect to ΔP_{excess} also increases, meaning that the OD_{cap} becomes more sensitive to changes in ΔP_{excess}. Therefore, from a process stability point-of-view, drawing a smaller sized capillary (i.e., smaller OD_{cap}) can reduce the sensitivity ΔOD_{cap} to changes in excess pressure (ΔP_{excess}). Additionally, the scale-up relationship of EQU. 1, which relates the slope of the sensitivity ΔOD with respect to ΔP_{excess} with draw tension can be roughly correlated with the target capillary size (i.e., OD_{cap}). For instance, similar to the scale-up relationship in FIG. 6 (labelled as “cap_1”), the scale-up relationship for a hollow-core optical fiber having a fiber microstructure with a different OD_{cap} (labelled as “cap_2”), such as in FIGS. 10 and/or 11, can be obtained via the following expressions in Equations 10 and 11 (EQU. 10 and EQU. 11).

$$[ {κ}_{cap \_ 1} \times \frac{1}{{OD}_{cap \_ 1}^{2}} ] ∼ [ {κ}_{cap \_ 2} \times \frac{1}{{OD}_{cap \_ 2}^{2}} ] \qquad EQU . 10$$

$${κ}_{cap \_ 2} \approx {( \frac{{OD}_{cap \_ 2}}{{OD}_{cap \_ 1}} )}^{2} \times {κ}_{cap \_ 1} = {( \frac{{OD}_{cap \_ 2}}{26.} )}^{2} \times [ A \times ( 54677 ) \times {τ}^{- 1} ] \qquad EQU . 11$$

In EQU. 10 and 11, κ_{cap_1} is the slope κ of the sensitivity ΔOD_{cap} with respect to ΔP_{excess} of a first hollow-core optical fiber having a first capillary outer diameter OD_{cap_1} in μm, and κ_{cap_2} is the slope κ of the sensitivity ΔOD_{cap} with respect to ΔP_{excess} of a second hollow-core optical fiber having a second capillary outer diameter OD_{cap_2} in μm. In EQU. 11, the first hollow-core optical fiber is the optical fiber of Table 1 having OD_{cap_1} equal to 26.0 μm. The relationship from EQU. 1 can be substituted for κ_{cap_1} to give EQU. 11. In EQU. 11, τ is the draw tension in grams. The term κ_{cap_2} in EQU. 11 can be replaced by ΔOD_{cap}/ΔP_{excess} and rearranged to give Equation 12 (EQU. 12).

$$Δ {OD}_{cap} = Δ {P}_{excess} \times {( \frac{{OD}_{cap}}{26.} )}^{2} \times ( A \times 54677 \times {τ}^{- 1} ) \qquad EQU . 12$$

In EQU. 12, “cap_2” is shortened to just “cap” so that ΔOD_{cap} is the change in capillary outer diameter of the second hollow-core optical fiber and OD_{cap} is the target capillary outer diameter of the second hollow-core optical fiber. In EQU. 12, A is the scaling factor defined in EQU. 2, τ is the draw tension in grams, and 54677 is an empirical constant derived from a fit of the modeled results in FIG. 6. In embodiments, the sensitivity ΔOD_{cap} satisfies the following condition:

$$0.9 \times [ Δ {P}_{excess} \times {( \frac{{OD}_{cap}}{26.} )}^{2} \times ( A \times 54677 \times {τ}^{- 1} ) ] \leq Δ {OD}_{cap} \leq 1.1 \times [ Δ {P}_{excess} \times {( \frac{{OD}_{cap}}{26.} )}^{2} \times ( A \times 54677 \times {τ}^{- 1} ) ] \qquad EQU . 12 A$$

or the condition:

$$0.95 \times [ Δ {P}_{excess} \times {( \frac{{OD}_{cap}}{26.} )}^{2} \times ( A \times 54677 \times {τ}^{- 1} ) ] \leq Δ {OD}_{cap} \leq 1.05 \times [ Δ {P}_{excess} \times {( \frac{{OD}_{cap}}{26.} )}^{2} \times ( A \times 54677 \times {τ}^{- 1} ) ] \qquad EQU . 12 B$$

EQU. 12 is optimized for a drawn hollow-core optical fiber with a microstructure having a target drawn capillary thickness of 538.5 nm, a target OD_{cladding} of 180 μm, and a target ID_{cladding} of 105 μm. However, the exponential relationship between the sensitivity ΔOD_{cap} and OD_{cap} and the inverse relationship between sensitivity ΔOD_{cap} and draw tension τ are independent of the target microstructure. Thus, EQU. 12 can be adapted to apply to other microstructure sizes and target dimensions through adjustment of the constants in EQU. 12. EQU. 12 can accordingly be generalized as follows in EQU. 12C:

$$Δ {OD}_{cap} = Δ {P}_{excess} \times {( \frac{{OD}_{cap}}{{C}_{4}} )}^{2} \times ( {C}_{1} \times {τ}^{- 1} ) \qquad EQU . 12 C$$

In EQU. 12C, C₁ is an empirical constant that can be determined as illustrated in FIG. 6 through experimentation or modeling. C₄ is a reference OD_{cap} in μm (i.e., OD_{cap_1} in EQUS. 10 and 11). In further embodiments, the sensitivity ΔOD_{cap} satisfies the following condition:

$$0.9 \times [ Δ {P}_{excess} \times {( \frac{{OD}_{cap}}{{C}_{4}} )}^{2} \times ( {C}_{1} \times {τ}^{- 1} ) ] \leq Δ {OD}_{cap} \leq 1.1 \times [ Δ {P}_{excess} \times {( \frac{{OD}_{cap}}{{C}_{4}} )}^{2} \times ( {C}_{1} \times {τ}^{- 1} ) ] \qquad EQU . 12 D$$

or the condition:

$$0.95 \times [ Δ {P}_{excess} \times {( \frac{{OD}_{cap}}{{C}_{4}} )}^{2} \times ( {C}_{1} \times {τ}^{- 1} ) ] \leq Δ {OD}_{cap} \leq 1.05 \times [ Δ {P}_{excess} \times {( \frac{{OD}_{cap}}{{C}_{4}} )}^{2} \times ( {C}_{1} \times {τ}^{- 1} ) ] \qquad EQU . 12 E$$

EQU. 12 can be modified to apply to any target OD_{cladding} by substituting EQU. 5 for EQU. 1 in EQU. 12 to obtain the following EQU. 13, which is valid for any target capillary size (OD_{cap}) and any OD_{cladding}.

$$Δ {OD}_{cap} = Δ {P}_{excess} \times {( \frac{{OD}_{cap}}{26.} )}^{2} \times ( 3.78011 \times \frac{1}{σ} \times \frac{{U}_{d}}{{U}_{p}} ) \qquad EQU . 13$$

In EQU. 13, σ is the draw stress in MPa as previously defined, U_{d} is the draw speed in mm/min, and Uₚ is the feed speed of the hollow-core preform in mm/min. In EQU. 13, the constant 3.78011 is an empirical constant derived from a fit of the modeled results in FIGS. 7 and 8. In further embodiments, the sensitivity ΔOD_{cap} satisfies the following condition:

$$0.9 \times [ Δ {P}_{excess} \times {( \frac{{OD}_{cap}}{26.} )}^{2} \times ( 3.78011 \times \frac{1}{σ} \times \frac{{U}_{d}}{{U}_{p}} ) ] \leq Δ {OD}_{cap} \leq 1.1 \times [ Δ {P}_{excess} \times {( \frac{{OD}_{cap}}{26.} )}^{2} \times ( 3.78011 \times \frac{1}{σ} \times \frac{{U}_{d}}{{U}_{p}} ) ] \qquad EQU . 13 A$$

or the condition:

$$0.95 \times [ Δ {P}_{excess} \times {( \frac{{OD}_{cap}}{26.} )}^{2} \times ( 3.78011 \times \frac{1}{σ} \times \frac{{U}_{d}}{{U}_{p}} ) ] \leq Δ {OD}_{cap} \leq 1.05 \times [ Δ {P}_{excess} \times {( \frac{{OD}_{cap}}{26.} )}^{2} \times ( 3.78011 \times \frac{1}{σ} \times \frac{{U}_{d}}{{U}_{p}} ) ] \qquad EQU . 13 B$$

EQU. 13 can be applied to estimate the sensitivity ΔOD_{cap} of hollow-core optical fibers having a target capillary thickness of 538.5 nm, an ID_{cladding} of 105 μm, and any capillary size (OD_{cap}) and OD_{cladding}. As indicated herein the exponential relationship between ΔOD_{cap} and OD_{cap} and the relationships between the sensitivity ΔOD_{cap} and the draw stress τ and draw down ratio (as represented by U_{d}/Uₚ), however, are independent of the target microstructure. Thus, EQU. 13 can be adapted to apply to other microstructure sizes and target dimensions through adjustment of the constants in EQU. 13. EQU. 13 can accordingly be generalized as follows in EQU. 13C.

$$Δ {OD}_{cap} = Δ {P}_{excess} \times {( \frac{{OD}_{cap}}{{C}_{4}} )}^{2} \times ( {C}_{2} \times \frac{1}{σ} \times \frac{{U}_{d}}{{U}_{p}} ) \qquad EQU . 13 C$$

In EQU. 13C, C₂ is an empirical constant that can be determined as illustrated in FIGS. 7 and 8 through experimentation or modeling. C₄ is a reference OD_{cap} in μm (i.e., OD_{cap_1} zin EQUS. 10 and 11). In embodiments, the sensitivity ΔOD_{cap} satisfies the following condition:

$$0.9 \times [ Δ {P}_{excess} \times {( \frac{{OD}_{cap}}{{C}_{4}} )}^{2} \times ( {C}_{2} \times \frac{1}{σ} \times \frac{{U}_{d}}{{U}_{p}} ) ] \leq Δ {OD}_{cap} \leq 1.1 \times [ Δ {P}_{excess} \times {( \frac{{OD}_{cap}}{{C}_{4}} )}^{2} \times ( {C}_{2} \times \frac{1}{σ} \times \frac{{U}_{d}}{{U}_{p}} ) ] \qquad EQU . 13 D$$

or the condition:

$$0.95 \times [ Δ {P}_{excess} \times {( \frac{{OD}_{cap}}{{C}_{4}} )}^{2} \times ( {C}_{2} \times \frac{1}{σ} \times \frac{{U}_{d}}{{U}_{p}} ) ] \leq Δ {OD}_{cap} \leq 1.05 \times [ Δ {P}_{excess} \times {( \frac{{OD}_{cap}}{{C}_{4}} )}^{2} \times ( {C}_{2} \times \frac{1}{σ} \times \frac{{U}_{d}}{{U}_{p}} ) ] \qquad EQU . 13 E$$

A method of making the hollow-core optical fiber can be based on any of the relationships in EQUS. 12, 12A, 12B, 12C, 12D, 12E, 13, 13A, 13B, 13C, 13D, or 13E. In embodiments, the method of producing the hollow-core optical fiber comprises feeding a hollow-core preform into a draw furnace at a preform feed rate, wherein the hollow-core preform comprises an outer tube and a plurality of inner tubes disposed within the outer tube, wherein the outer tube has an outer diameter OD_{preform} and an inner diameter ID_{preform}. The methods further include heating the hollow-core preform in the draw furnace and drawing a hollow-core optical fiber from the hollow-core preform. The hollow-core optical fiber may be drawn from the hollow-core preform at a fiber draw rate, a draw tension τ, a core pressure P_{core} in a hollow-core of the hollow-core preform, and a capillary pressure P_{cap} in the plurality of inner tubes, thereby elongating the outer tube and the plurality of inner tubes of the hollow-core preform to produce the hollow-core optical fiber having an outer cladding, a plurality of drawn capillaries disposed within the outer cladding, and an interior cavity. The plurality of drawn capillaries of the hollow-core optical fiber have an outer diameter OD_{cap} (in μm), and the excess pressure P_{excess} is equal to a difference between the core pressure P_{core} and the capillary pressure P_{cap}. The drawn capillary outer diameter sensitivity ΔOD_{cap} (in μm), which is defined as a variation in the outer diameter OD_{cap} of the plurality of drawn capillaries of the hollow-core optical fiber per change in the excess pressure ΔP_{excess}, may satisfy the relationship in any one of EQUS. 13, 13A, 13B, 13C, 13D, or 13E.

In embodiments, the plurality of drawn capillaries may have a target thickness t_{cap} of about 538.5 nm. In embodiments, the ΔP_{excess} may be from about 0.001 psig to about 0.02 psig. In embodiments, the hollow-core optical fiber may have a cladding inner diameter ID_{cladding} of about 105 μm. In embodiments, the outer cladding may have a cladding outer diameter OD_{cladding} of from about 150 μm to about 300 μm. In embodiments, the outer cladding may have a cladding outer diameter OD_{cladding} of about 180 μm, and the drawn capillary outer diameter sensitivity ΔOD_{cap} (in μm) may satisfy the relationship in any one of EQUS. 12, 12A, 12B, 12C, 12D, or 12D. In embodiments, the plurality of drawn capillaries have a target outer diameter OD_{cap} of about 26.0 μm, and the drawn capillary outer diameter sensitivity ΔOD_{cap} (in μm) may satisfy the relationships in any one of EQUS. 1, 1A, 1B, 1C, 1D, or 1E.

### Operating Parameters

The various methods and relationships described herein may be implemented with a wide range of operating parameters for scaling-up the process for drawing hollow-core optical fibers from hollow-core preforms of various sizes while maintaining a tight control over target microstructure dimensions of the hollow-core optical fibers drawn.

### Draw Tension

In embodiments, the draw tension under which the hollow-core optical fiber may be drawn from a hollow-core preform may be greater than or equal to (i.e., ≥) 50 grams (g) and less than or equal to (i.e., ≤) 600 g—including all sub-ranges or values therebetween. In embodiments, the draw tension may be ≥50 g and ≤600 g, such as ≥50 g and ≤550 g, ≥50 g and ≤500 g, ≥50 g and ≤450 g, ≥50 g and ≤400 g, ≥50 g and ≤350 g, ≥50 g and ≤300 g, ≥50 g and ≤250 g, ≥50 g and ≤200 g, ≥50 g and ≤150 g, ≥50 g and ≤100 g, ≥100 g and ≤600 g, ≥100 g and ≤550 g, ≥100 g and ≤500 g, ≥100 g and ≤450 g, ≥100 g and ≤400 g, ≥100 g and ≤350 g, ≥100 g and ≤300 g, ≥100 g and ≤250 g, ≥100 g and ≤200 g, ≥100 g and ≤150 g, ≥150 g and ≤600 g, ≥150 g and ≤550 g, ≥150 g and ≤500 g, ≥150 g and ≤450 g, ≥150 g and ≤400 g, ≥150 g and ≤350 g, ≥150 g and ≤300 g, ≥150 g and ≤250 g, ≥150 g and ≤200 g, ≥200 g and ≤600 g, ≥200 g and ≤550 g, ≥200 g and ≤500 g, ≥200 g and ≤450 g, ≥200 g and ≤400 g, ≥200 g and ≤350 g, ≥200 g and ≤300 g, ≥200 g and ≤250 g, ≥250 g and ≤600 g, ≥250 g and ≤550 g, ≥250 g and ≤500 g, ≥250 g and ≤450 g, ≥250 g and ≤400 g, ≥250 g and ≤350 g, ≥250 g and ≤300 g, ≥300 g and ≤600 g, ≥300 g and ≤550 g, ≥300 g and ≤500 g, ≥300 g and ≤450 g, ≥300 g and ≤400 g, ≥300 g and ≤350 g, ≥350 g and ≤600 g, ≥350 g and ≤550 g, ≥350 g and ≤500 g, ≥350 g and ≤450 g, ≥350 g and ≤400 g, ≥400 g and ≤600 g, ≥400 g and ≤550 g, ≥400 g and ≤500 g, ≥400 g and ≤450 g, ≥450 g and ≤600 g, ≥450 g and ≤550 g, ≥450 g and ≤500 g, ≥500 g and ≤600 g, ≥500 g and ≤550 g, ≥550 g and ≤600 g, or ≥550 g and ≤600 g, including any ranges or sub-ranges therebetween.

In embodiments, the draw tension under which the hollow-core optical fiber may be drawn from a hollow-core preform may be greater than or equal to (i.e., ≥) 50 g, ≥70 g, ≥90 g, ≥110 g, ≥130 g, ≥150 g, ≥170 g, ≥190 g, ≥210 g, ≥230 g, ≥250 g, ≥270 g, ≥290 g, ≥310 g, ≥330 g, ≥350 g, ≥370 g, ≥390 g, ≥410 g, ≥430 g, ≥450 g, ≥470 g, ≥490 g, ≥510 g, ≥530 g, ≥550 g, ≥570 g, ≥590 g, or greater. In embodiments, the draw tension under which the hollow-core optical fiber may be drawn from the hollow-core preform may be less than or equal to (i.e., ≤) 600 g, ≤580 g, ≤560 g, ≤540 g, ≤520 g, ≤500 g, ≤480 g, ≤460 g, ≤440 g, ≤420 g, 400 g, ≤380 g, ≤360 g, ≤340 g, ≤320 g, ≤300 g, ≤280 g, ≤260 g, ≤240 g, ≤220 g, ≤200 g, ≤180 g, ≤160 g, ≤140 g, ≤120 g, ≤100 g, ≤80 g, ≤60 g, or less.

### Draw Speed

In some embodiments, the hollow-core optical fiber may be drawn at a draw speed (U_{d} in mm/min divided by 60,000 m/s per mm/min) of greater than or equal to (i.e., ≥) 0.1 m/s and less than or equal to (i.e., ≤) 60 m/s—including all sub-ranges or values therebetween. For example, in embodiments, the draw speed may be ≥0.1 m/s and ≤20 m/s, ≥0.1 m/s and ≤15 m/s, ≥0.1 m/s and ≤10 m/s, ≥0.1 m/s and ≤5 m/s, ≥1 m/s and ≤60 m/s, ≥1 m/s and ≤20 m/s, ≥1 m/s and ≤15 m/s, ≥1 m/s and ≤10 m/s, ≥1 m/s and ≤5 m/s, ≥5 m/s and ≤60 m/s, ≥5 m/s and ≤20 m/s, ≥5 m/s and ≤15 m/s, ≥5 m/s and ≤10 m/s, ≥10 m/s and ≤60 m/s, ≥10 m/s and ≤20 m/s, ≥10 m/s and ≤15 m/s, ≥15 m/s and ≤60 m/s, or ≥15 m/s and ≤20 m/s, including any ranges or sub-ranges therebetween. In embodiments, the hollow-core optical fiber may be drawn at a draw speed of greater than or equal to (i.e., ≥) 0.1 m/s, ≥1 m/s, ≥3 m/s, ≥5 m/s, ≥7 m/s, ≥9 m/s, ≥11 m/s, ≥13 m/s, ≥15 m/s, ≥17 m/s, ≥19 m/s, ≥20 m/s, or greater.

### Preform Feed Rate

In embodiments, the hollow-core preform may be fed into the draw furnace at a preform feed rate Uₚ that may be greater than or equal to (i.e., ≥) 5 mm/min and less than or equal to (i.e., ≤) 100 mm/min—including all sub-ranges or values therebetween. In embodiments, the hollow-core preform may be fed into the draw furnace at a preform feed rate Uₚ that may be ≥5 mm/min and ≤100 mm/min, ≥5 mm/min and ≤75 mm/min, ≥5 mm/min and ≤50 mm/min, ≥5 mm/min and ≤25 mm/min, ≥25 mm/min and ≤100 mm/min, ≥25 mm/min and ≤75 mm/min, ≥25 mm/min and ≤50 mm/min, ≥50 mm/min and ≤100 mm/min, ≥50 mm/min and ≤75 mm/min, or ≥75 mm/min and ≤100 mm/min, including any ranges or sub-ranges therebetween. In embodiments, the hollow-core preform may be fed into the draw furnace at a preform feed rate Uₚ that may be ≥5 mm/min, ≥10 mm/min, ≥15 mm/min, ≥20 mm/min, ≥25 mm/min, ≥30 mm/min, ≥35 mm/min, ≥40 mm/min, ≥45 mm/min, ≥50 mm/min, ≥55 mm/min, ≥60 mm/min, ≥65 mm/min, ≥70 mm/min, ≥75 mm/min, ≥80 mm/min, ≥85 mm/min, ≥90 mm/min, ≥95 mm/min, or greater. In embodiments, the hollow-core preform may be fed into the draw furnace at a preform feed rate Uₚ that may be less than or equal to 100 mm/min, ≤95 mm/min, ≤90 mm/min, ≤85 mm/min, ≤80 mm/min, ≤75 mm/min, ≤70 mm/min, ≤65 mm/min, ≤60 mm/min, ≤55 mm/min, ≤50 mm/min, ≤45 mm/min, ≤40 mm/min, ≤35 mm/min, ≤30 mm/min, ≤25 mm/min, ≤20 mm/min, ≤15 mm/min, ≤10 mm/min, or less.

### Differential Core Pressure P_{core}

In embodiments, the differential core pressure P_{core} may be greater than or equal to (i.e., ≥) 0.01 psig and less than or equal to (i.e., ≤) 2 psig—including all sub-ranges or values therebetween. In embodiments, the differential core pressure P_{core} may be may be ≥0.01 psig and ≤2 psig, ≥0.01 psig and ≤1.5, ≥0.01 psig and ≤1, ≥0.01 psig and ≤0.5, ≥0.01 psig and ≤0.1 psig, ≥0.1 psig and ≤2 psig, ≥0.1 psig and ≤1.5, ≥0.1 psig and ≤1, ≥0.1 psig and ≤0.5, ≥0.5 psig and ≤2 psig, ≥0.5 psig and ≤1.5, ≥0.5 psig and ≤1, ≥1 psig and ≤2 psig, ≥1 psig and ≤1.5, or ≥1.5 psig and ≤2 psig. For purposes of unit conversion, 1 psig (pounds per square inch gauge pressure) is equal to 6.89 kPa gauge pressure.

In embodiments, the differential core pressure P_{core} may be greater than or equal to (i.e., ≥) 0.01 psig, ≥0.05 psig, ≥0.1 psig, ≥0.2 psig, ≥0.3 psig, ≥0.4 psig, ≥0.5 psig, ≥0.6 psig, ≥0.7 psig, ≥0.8 psig, ≥0.9 psig, ≥1 psig, ≥1.1 psig, ≥1.2 psig, ≥1.3 psig, ≥1.4 psig, ≥1.5 psig, ≥1.6 psig, ≥1.7 psig, ≥1.8 psig, ≥1.9 psig, or greater. In embodiments, the differential core pressure P_{core} may be less than or equal to (i.e., ≤) 2 psig, ≤1.9 psig, ≤1.8 psig, ≤1.7 psig, ≤1.6 psig, ≤1.5 psig, ≤1.4 psig, ≤1.3 psig, ≤1.2 psig, ≤1.1 psig, ≤1 psig, ≤0.9 psig, ≤0.8 psig, ≤0.7 psig, ≤0.6 psig, ≤0.5 psig, ≤0.4 psig, ≤0.3 psig, ≤0.2 psig, ≤0.1 psig, ≤0.05 psig, or less.

### Preform Outer Tube Dimensions

In embodiments, the inner diameter of the outer tube of the hollow-core preform (ID_{Preform}=2×rₚ) may be greater than or equal to (i.e., ≥) 4 mm and less than or equal to (i.e., ≤) 20 mm—including all sub-ranges or values therebetween. In embodiments, the inner diameter of the outer tube of the hollow-core preform (ID_{Preform}=2×rₚ) may be ≥4 mm and ≤20 mm, ≥4 mm and ≤16 mm, ≥4 mm and ≤12 mm, ≥4 mm and 8 mm, ≥8 mm and ≤20 mm, ≥8 mm and ≤16 mm, ≥8 mm and ≤12 mm, ≥12 mm and ≤20 mm, ≥12 mm and ≤16 mm, or ≥16 mm and ≤20 mm, including any range or sub-range therebetween. In embodiments, the inner diameter of the outer tube of the hollow-core preform (ID_{Preform}=2×rₚ) may be greater than or equal to (i.e., ≥) 4 mm, ≥5 mm, ≥6 mm, ≥7 mm, ≥8 mm, ≥9 mm, ≥10 mm, ≥11 mm, ≥12 mm, ≥13 mm, ≥14 mm, ≥15 mm, ≥16 mm, ≥17 mm, ≥18 mm, ≥19 mm, or greater. In embodiments, the inner diameter of the outer tube of the hollow-core preform (ID_{Preform}=2×rₚ) may be less than or equal to (i.e., ≤) 20 mm, ≤19 mm, ≤18 mm, ≤17 mm, ≤16 mm, ≤15 mm, ≤14 mm, ≤13 mm, ≤12 mm, ≤11 mm, ≤10 mm, ≤9 mm, ≤8 mm, ≤7 mm, ≤6 mm, ≤5 mm, or less.

In embodiments, the outer diameter of the outer tube of the hollow-core preform (OD_{preform}=2×Rₚ) may be greater than or equal to (i.e., ≥) 15 mm and less than or equal to (i.e., ≤) to 100 mm—including all sub-ranges or values therebetween. In embodiments, the outer diameter of the outer tube of the hollow-core preform (OD_{preform}=2×Rₚ) may be ≥15 mm and ≤100 mm, ≥15 mm and ≤75 mm, ≥15 mm and ≤50 mm, ≥15 mm and ≤25 mm, ≥25 mm and ≤100 mm, ≥25 mm and ≤75 mm, ≥25 mm and ≤50 mm, ≥50 mm and ≤100 mm, ≥50 mm and ≤75 mm, or ≥75 mm and ≤100 mm, including any ranges or sub-ranges therebetween. In embodiments, the outer diameter of the outer tube of the hollow-core preform (OD_{preform}=2×Rₚ) may be greater than or equal to (i.e., ≥) 15 mm, ≥20 mm, ≥25 mm, ≥30 mm, ≥35 mm, ≥40 mm, ≥45 mm, ≥50 mm, ≥55 mm, ≥60 mm, ≥65 mm, ≥70 mm, ≥75 mm, ≥80 mm, ≥85 mm, ≥90 mm, ≥95 mm, or greater. In embodiments, the outer diameter of the outer tube of the hollow-core preform (OD_{preform}=2×Rₚ) may be less than or equal to (i.e., ≤) 100 mm, ≤95 mm, ≤90 mm, ≤85 mm, ≤80 mm, ≤75 mm, ≤70 mm, ≤65 mm, ≤60 mm, ≤55 mm, ≤50 mm, ≤45 mm, ≤40 mm, ≤35 mm, ≤30 mm, ≤25 mm, ≤20 mm, or less.

### Fiber Outer Cladding Dimensions

In embodiments, the inner diameter of the outer cladding of the hollow-core optical fiber (ID_{fiber}=2×r_{f}) may be greater than or equal to (i.e., ≥) 45 μm and less than or equal to (i.e., ≤) 135 μm—including all sub-ranges or values therebetween. For example, in embodiments, the inner diameter of the outer cladding of the hollow-core optical fiber (ID_{fiber}=2×r_{f}) may be ≥45 μm and ≤135 μm, ≥45 μm and ≤115 μm, ≥45 μm and ≤95 μm, ≥45 μm and ≤75 μm, ≥45 μm and ≤55 μm, ≥55 μm and ≤135 μm, ≥55 μm and ≤115 μm, ≥55 μm and ≤95 μm, ≥55 μm and ≤75 μm, ≥75 μm and ≤135 μm, ≥75 μm and ≤115 μm, ≥75 μm and ≤95 μm, ≥95 μm and ≤135 μm, ≥95 μm and ≤115 μm, or ≥115 μm and ≤135 μm, including any ranges or sub-ranges therebetween. In embodiments, the inner diameter of the outer cladding of the hollow-core optical fiber (ID_{fiber}=2×r_{f}) may be greater than or equal to (i.e., ≥) 45 μm, ≥50 mm, ≥55 mm, ≥60 mm, ≥65 mm, ≥70 mm, ≥75 mm, ≥80 mm, ≥85 mm, ≥90 mm, ≥95 mm, ≥100 mm, ≥105 mm, ≥110 mm, ≥115 mm, ≥120 mm, ≥125 mm, ≥130 μm, or greater. In embodiments, the inner diameter of the outer cladding of the hollow-core optical fiber (ID_{fiber}=2×r_{f}) may be less than or equal to (i.e., ≤) 135 μm, ≤130 μm, ≤125 μm, ≤120 μm, ≤115 μm, ≤110 μm, ≤105 μm, ≤100 μm, ≤95 μm, ≤90 μm, ≤85 μm, ≤80 μm, ≤75 μm, ≤70 μm, ≤65 μm, ≤60 μm, ≤55 μm, ≤50 μm, or less.

In embodiments, the outer diameter of the outer cladding of the hollow-core optical fiber (2×R_{ocf}) may be greater than or equal to (i.e., ≥) 150 μm and less than or equal to (i.e., ≤) 300 μm—including all sub-ranges or values therebetween. In embodiments, the outer diameter of the outer cladding of the hollow-core optical fiber (2×R_{ocf}) may be ≥150 μm and ≤300 μm, ≥150 μm and ≤250 μm, ≥150 μm and ≤200 μm, ≥200 μm and ≤300 μm, ≥200 μm and ≤250 μm, or ≥250 μm and ≤300 μm. In embodiments, the outer diameter of the outer cladding of the hollow-core optical fiber (2×R_{ocf}) may be greater than or equal to (i.e., ≥) 150 μm, ≥160 μm, ≥170 μm, ≥180 μm, ≥190 μm, ≥200 μm, ≥210 μm, ≥220 μm, ≥230 μm, ≥240 μm, ≥250 μm, ≥260 μm, ≥270 μm, ≥280 μm, ≥290 μm, or greater. In embodiments, the outer diameter of the outer cladding of the hollow-core optical fiber (2×R_{ocf}) may be less than or equal to (i.e., ≤) 300 μm, ≤290 μm, ≤280 μm, ≤270 μm, ≤260 μm, ≤250 μm, ≤240 μm, ≤230 μm, ≤220 μm, ≤210 μm, ≤200 μm, ≤190 μm, ≤180 μm, ≤170 μm, ≤160 μm, or less.

In embodiments, the outer diameter of the plurality of drawn capillaries of the hollow-core optical fiber (OD_{cap}) may be greater than or equal to (i.e., ≥) 14 μm and less than or equal to (i.e., ≤) 32 μm—including all sub-ranges or values therebetween. In embodiments, the outer diameter of the drawn capillaries of the hollow-core optical fiber (OD_{cap}) may be ≥14 μm and ≤30 μm, ≥14 μm and ≤28 μm, ≥14 μm and ≤26 μm, ≥16 μm and ≤32 μm, ≥16 μm and ≤30 μm, ≤16 μm and ≤28 μm, ≤16 μm and ≤26 μm, ≤18 μm and ≤32 μm, ≤18 μm and ≤30 μm, ≥18 μm and ≤28 μm, ≥18 μm and ≤26 μm, ≥20 μm and ≤32 μm, ≥20 μm and ≤30 μm, ≥20 μm and ≤28 μm, ≥20 μm and ≤26 μm, ≥22 μm and ≤32 μm, ≥22 μm and ≤30 μm, ≥22 μm and ≤28 μm, ≥22 μm and ≤26 μm, ≥24 μm and ≤32 μm, ≥24 μm and ≤30 μm, ≥24 μm and ≤28 μm, ≥24 μm and ≤26 μm, ≥26 μm and ≤32 μm, ≥26 μm and ≤30 μm, or ≥26 μm and ≤28 μm, including any range or subrange therebetween. In embodiments, the outer diameter of the drawn capillaries of the hollow-core optical fiber (OD_{cap}) may be greater than or equal to (i.e., ≥) 14 μm, ≥15 μm, ≥16 μm, ≥17 μm, ≥18 μm, ≥19 μm, ≥20 μm, ≥21 μm, ≥22 μm, ≥23 μm, ≥24 μm, ≥25 μm, ≥26 μm, ≥27 μm, ≥28 μm, ≥29 μm, ≥30 μm, ≥31 μm, or greater. In embodiments, the outer diameter of the drawn capillaries of the hollow-core optical fiber (OD_{cap}) may be less than or equal to (i.e., ≤) 32 μm, ≤30 μm, ≤29 μm, ≤28 μm, ≤27 μm, ≤26 μm, ≤25 μm, ≤24 μm, ≤23 μm, ≤22 μm, ≤21 μm, ≤20 μm, ≤19 μm, ≤18 μm, ≤17 μm, ≤16 μm, ≤15 μm, or less.

In embodiments, the wall thickness of the plurality of drawn capillaries of the hollow-core optical fiber (t_{cap}) may be greater than or equal to (i.e., ≥) 400 nm and less than or equal (i.e., ≤) 2,000 nm—including all sub-ranges or values therebetween. In embodiments, the wall thickness of the plurality of drawn capillaries of the hollow-core optical fiber (t_{cap}) may be ≥400 nm and ≤1,800 nm, ≥400 nm and ≤1,600 nm, ≥400 nm and ≤1,400 nm, ≥400 μm and ≤1,200 nm, ≥400 nm and ≤1,100 nm, ≥500 nm and ≤2,000 nm, ≥500 nm and ≤1,800 nm, ≥500 nm and ≤1,600 nm, ≥500 nm and ≤1,400 nm, ≥500 nm and ≤1,200 nm, ≥500 μm and ≤1,100 nm, ≥500 nm and ≤1,000 nm, ≥600 nm and ≤2,000 nm, ≥600 nm and ≤1,800 nm, ≥600 nm and ≤1,600 nm, ≥600 nm and ≤1,400 nm, ≥600 nm and ≤1,200 nm, ≥600 nm and ≤1,100 nm, ≥600 nm and ≤1,000 nm, ≥800 nm and ≤2,000 nm, ≥800 nm and ≤1,800 nm, ≥800 nm and ≤1,600 nm, ≥800 nm and ≤1,400 nm, ≥800 nm and ≤1,200 nm, ≥800 nm and ≤1,100 nm, or ≥800 nm and ≤1,000 nm, including any range or subrange therebetween. In embodiments, the wall thickness of the plurality of drawn capillaries of the hollow-core optical fiber (t_{cap}) may be greater than or equal to (i.e., ≥) 400 nm, ≥500 nm, ≥538.5 nm, ≥550 nm, ≥600 nm, ≥700 nm, ≥800 nm, ≥900 nm, ≥1,000 nm, ≥1,100 nm, ≥1,200 nm, ≥1,300 nm, ≥1,400 nm, ≥1,500 nm, ≥1,600 nm, ≥1,700 nm, ≥1,800 nm, ≥1,900 nm, or greater. In embodiments, the wall thickness of the plurality of drawn capillaries of the hollow-core optical fiber (t_{cap}) may be less than or equal to (i.e., ≤) 2,000 nm, ≤1,900 nm, ≤1,800 nm, ≤1,700 nm, ≤1,600 nm, ≤1,500 nm, ≤1,400 nm, ≤1,300 nm, ≤1,200 nm, ≤1,100 nm, ≤1,077 nm, ≤1,000 nm, ≤900 nm, ≤800 nm, ≤700 nm, ≤600 nm, ≤500 nm, or less. In embodiments, the wall thickness of the plurality of drawn capillaries of the hollow-core optical fiber (t_{cap}) may be greater than or equal to 538.5 nm and less than or equal to 1077 nm—including all sub-ranges or values therebetween.

### EXAMPLES

The various embodiments of the methods disclosed herein will be further clarified by the following examples. The examples are illustrative in nature and should not be understood to limit the subject matter of the present disclosure.

In the following examples, the drawn hollow-core optical fiber is assumed to have a target microstructure with a target cladding inner diameter ID_{cladding}=105.0 μm, a target cladding outer diameter OD_{cladding}=180.0 μm, a target capillary inner diameter ID_{cap}=24.923 μm, and target capillary outer diameter OD_{cap}=26.0 μm.

### Examples 1-6

In Examples 1-6, the hollow-core optical fiber is drawn from a hollow-core preform having a starting outer tube diameter OD_{outer_tube} in a range of from 14.0 mm to 20.0 mm (i.e., 14.0 mm≤OD_{outer_tube}≤20.0 mm). The required draw down ratio to achieve the target microstructure is from 8.87 to 9.59 (i.e., 8.87≤β≤9.59). For each of Examples 1-6, the ΔP_{excess} in psig is set and the draw tension and draw stress are calculated to achieve a target sensitivity ΔOD_{cap} using the relationships described in the present disclosure, the ranges for draw tension and draw stress calculated for each of Examples 1-6 are provided in Table 8.

TABLE 8
Calculated ranges for draw tension and draw stress for Examples 1-6.

| | | | | sensitivity | Draw | Draw |
|---|---|---|---|---|---|---|
| | ODₒᵤₜₑᵣ_{_{—}}_{tube} | | ΔP_{excess} | ΔOD_{cap} | tension τ | stress σ |
| Ex. | (mm) | β | (psig) | (μm) | (grams) | (MPa) |
| 1 | 14.0-20.0 | 8.87-9.59 | ≤10⁻⁴ | ≤2.0 | 85-600 | 50-350 |
| 2 | 14.0-20.0 | 8.87-9.59 | 10⁻⁴-10⁻³ | <2.0 | 85-600 | 50-350 |
| 3 | 14.0-20.0 | 8.87-9.59 | 10⁻³-10⁻² | <2.0 | 425-600 | 250-350 |
| 4 | 14.0-20.0 | 8.87-9.59 | 10⁻³-10⁻² | 1.0-2.0 | 350-600 | 205-350 |
| 5 | 14.0-20.0 | 8.87-9.59 | ≤10⁻⁴ | <1.0 | 85-600 | 50-350 |
| 6 | 14.0-20.0 | 8.87-9.59 | 10⁻⁴-10⁻³ | ≤1.0 | 100-600 | 59-350 |

### Examples 7-14

In Examples 7-14, the hollow-core optical fiber is drawn from a hollow-core preform having a starting outer tube diameter OD_{outer_tube} in a range of from 22.5 mm to 27.5 mm (i.e., 22.5 mm≤OD_{outer_tube}≤27.5 mm). The required draw down ratio to achieve the target microstructure is from 9.82 to 10.22 (i.e., 9.82≤β≤10.22). For each of Examples 7-14, the ΔP_{excess} in psig is set and the draw tension and draw stress are calculated to achieve a target sensitivity ΔOD_{cap} using the relationships described in the present disclosure, the ranges for draw tension and draw stress calculated for each of Examples 7-14 are provided in Table 9.

TABLE 9
Calculated ranges for draw tension and draw stress for Examples 7-14.

| | | | | sensitivity | Draw | Draw |
|---|---|---|---|---|---|---|
| | ODₒᵤₜₑᵣ_{_{—}}_{tube} | | ΔP_{excess} | ΔOD_{cap} | tension τ | stress σ |
| Ex. | (mm) | β | (psig) | (μm) | (grams) | (MPa) |
| 7 | 22.5-27.5 | 9.82-10.22 | ≤10⁻⁴ | ≤2.0 | 85-600 | 50-350 |
| 8 | 22.5-27.5 | 9.82-10.22 | 10⁻⁴-10⁻³ | ≤2.0 | 85-600 | 50-350 |
| 9 | 22.5-27.5 | 9.82-10.22 | 10⁻³-10⁻² | ≤2.0 | >600 | >350 |
| 10 | 22.5-27.5 | 9.82-10.22 | 10⁻⁴-10⁻³ | 1.0-2.0 | <100 | <59 |
| 11 | 22.5-27.5 | 9.82-10.22 | 10⁻³-10⁻² | 1.0-2.0 | >600 | >350 |
| 12 | 22.5-27.5 | 9.82-10.22 | ≤10⁻⁴ | ≤1.0 | 85-600 | 50-350 |
| 13 | 22.5-27.5 | 9.82-10.22 | 10⁻⁴-10⁻³ | ≤1.0 | 200-600 | 117-350 |
| 14 | 22.5-27.5 | 9.82-10.22 | 10⁻³-10⁻² | ≤1.0 | >600 | >350 |

### Examples 15-19

In Examples 15-19, the hollow-core optical fiber is drawn from a hollow-core preform having a starting outer tube diameter OD_{outer_tube} in a range of from 35.0 mm to 40.0 mm (i.e., 35.0 mm≤OD_{outer_tube}≤40.0 mm). The required draw down ratio to achieve the target microstructure is from 10.71 to 10.97 (i.e., 10.71≤β≤10.97). For each of Examples 15-19, the ΔP_{excess} in psig is set and the draw tension and draw stress are calculated to achieve a target sensitivity ΔOD_{cap} using the relationships described in the present disclosure, the ranges for draw tension and draw stress calculated for each of Examples 15-19 are provided in Table 10.

TABLE 10
Calculated ranges for draw tension and draw stress for Examples 15-19.

| | | | | sensitivity | Draw | Draw |
|---|---|---|---|---|---|---|
| | ODₒᵤₜₑᵣ_{_{—}}_{tube} | | ΔP_{excess} | ΔOD_{cap} | tension τ | stress σ |
| Ex. | (mm) | β | (psig) | (μm) | (grams) | (MPa) |
| 15 | 35.0-40.0 | 10.71-10.97 | ≤10⁻⁴ | ≤2.0 | 85-600 | 50-350 |
| 16 | 35.0-40.0 | 10.71-10.97 | 10⁻⁴-10⁻³ | ≤2.0 | 200-600 | 117-350 |
| 17 | 35.0-40.0 | 10.71-10.97 | 10⁻⁴-10⁻³ | 1.0-2.0 | 175-225 | 102-131 |
| 18 | 35.0-40.0 | 10.71-10.97 | ≤10⁻⁴ | ≤1.0 | 85-600 | 50-350 |
| 19 | 35.0-40.0 | 10.71-10.97 | 10⁻⁴-10⁻³ | ≤1.0 | 375-600 | 219-350 |

### Examples 20-25

In Examples 20-25, the hollow-core optical fiber is drawn from a hollow-core preform having a starting outer tube diameter OD_{outer_tube} in a range of from 47.5 mm to 52.5 mm (i.e., 47.5 mm≤OD_{outer_tube}≤52.5 mm). The required draw down ratio to achieve the target microstructure is from 11.32 to 11.52 (i.e., 11.32≤β≤11.52). For each of Examples 20-25, the ΔP_{excess} in psig is set and the draw tension and draw stress are calculated to achieve a target sensitivity ΔOD_{cap} using the relationships described in the present disclosure, the ranges for draw tension and draw stress calculated for each of Examples 20-25 are provided in Table 11.

TABLE 11
Calculated ranges for draw tension and draw stress for Examples 20-25.

| | | | | sensitivity | Draw | Draw |
|---|---|---|---|---|---|---|
| | ODₒᵤₜₑᵣ_{_{—}}_{tube} | | ΔP_{excess} | ΔOD_{cap} | tension τ | stress σ |
| Ex. | (mm) | β | (psig) | (μm) | (grams) | (MPa) |
| 20 | 47.5-52.5 | 11.32-11.52 | ≤10⁻⁴ | ≤2.0 | 85-600 | 50-350 |
| 21 | 47.5-52.5 | 11.32-11.52 | 10⁻⁴-10⁻³ | ≤2.0 | 350-600 | 205-350 |
| 22 | 47.5-52.5 | 11.32-11.52 | ≤10⁻⁴ | 1.0-2.0 | <50 | <29 |
| 23 | 47.5-52.5 | 11.32-11.52 | 10⁻⁴-10⁻³ | 1.0-2.0 | 250-375 | 146-219 |
| 24 | 47.5-52.5 | 11.32-11.52 | ≤10⁻⁴ | ≤1.0 | 100-600 | 59-350 |
| 25 | 47.5-52.5 | 11.32-11.52 | 10⁻⁴-10⁻³ | ≤1.0 | 515-600 | 301-350 |

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A method of producing a hollow-core optical fiber, the method comprising:
feeding a hollow-core preform into a draw furnace at a preform feed rate, wherein the hollow-core preform comprises an outer tube and a plurality of inner tubes disposed within the outer tube, wherein the outer tube has an outer diameter OD_{preform} and an inner diameter ID_{preform},
heating the hollow-core preform in the draw furnace;
drawing a hollow-core optical fiber from the hollow-core preform at a fiber draw rate, a draw stress, a draw tension τ, a core pressure P_{core} in a hollow-core of the hollow-core preform, and a capillary pressure P_{cap} in the plurality of inner tubes, thereby elongating the outer tube and the plurality of inner tubes of the hollow-core preform to produce the hollow-core optical fiber having an outer cladding, a plurality of drawn capillaries disposed within the outer cladding, and an interior cavity, wherein:
the plurality of drawn capillaries of the hollow-core optical fiber have an outer diameter OD_{cap} (in μm);
an excess pressure P_{excess} (in psig) is equal to a difference between the core pressure P_{core} (in psig) and the capillary pressure P_{cap} (in psig); and
a drawn capillary outer diameter sensitivity ΔOD_{cap} (in μm), which is defined as a variation in the outer diameter OD_{cap} of the plurality of drawn capillaries of the hollow-core optical fiber per change in the excess pressure ΔP_{excess}, satisfies the following:
$$0.9 \times ( Δ {P}_{excess} \times 3.78011 \times \frac{1}{σ} \times \frac{{U}_{d}}{{U}_{p}} ) \leq Δ {OD}_{cap} \leq 1.1 \times ( Δ {P}_{excess} \times 3.78011 \times \frac{1}{σ} \times \frac{{U}_{d}}{{U}_{p}} )$$
where σ is the draw stress in MPa, U_{d} is the fiber draw rate in mm/min, and Uₚ is the preform feed rate in mm/min.

2. The method of claim 1, wherein the plurality of drawn capillaries have a target thickness of about 538.5 nm and a target outer diameter OD_{cap} of about 26.0 μm.

3. The method of claim 1, wherein the ΔP_{excess} is from about 0.001 psig to about 0.02 psig.

4. The method of claim 1, wherein the outer cladding of the hollow-core optical fiber has a cladding inner diameter ID_{cladding} of about 105 μm, a cladding outer diameter OD_{cladding} of from about 150 μm to about 300 μm, or both.

5. The method of claim 1, wherein the hollow-core optical fiber has a cladding outer diameter OD_{cladding} of about 180 μm and the drawn capillary outer diameter sensitivity ΔOD_{cap} (in μm) satisfies the following:
0.90×(ΔP_{excess}×A×54677×τ⁻¹)≤ΔOD_{cap}≤1.10×(ΔP_{excess}×A×54677×τ⁻¹)
where A is a scaling factor and
$$A = \frac{{OD}_{preform}^{2} - {ID}_{preform}^{2}}{225} ;$$
and τ is the draw tension in grams.

6. A method of producing a hollow-core optical fiber, the method comprising:
feeding a hollow-core preform into a draw furnace at a preform feed rate, wherein the hollow-core preform comprises an outer tube and a plurality of inner tubes disposed within the outer tube, wherein the outer tube has an outer diameter OD_{preform} and an inner diameter ID_{preform},
heating the hollow-core preform in the draw furnace;
drawing a hollow-core optical fiber from the hollow-core preform at a fiber draw rate, a draw tension τ, a core pressure P_{core} in a hollow-core of the hollow-core preform, and a capillary pressure P_{cap} in the plurality of inner tubes, thereby elongating the outer tube and the plurality of inner tubes of the hollow-core preform to produce the hollow-core optical fiber having an outer cladding, a plurality of drawn capillaries disposed within the outer cladding, and an interior cavity, wherein:
the plurality of drawn capillaries of the hollow-core optical fiber have an outer diameter OD_{cap} (in μm) and a thickness t_{cap} (in nm);
an excess pressure P_{excess} (in psig) is equal to a difference between the core pressure P_{core} (in psig) and the capillary pressure P_{cap} (in psig); and
a drawn capillary outer diameter sensitivity ΔOD_{cap} (in μm), which is defined as a variation in the outer diameter OD_{cap} of the plurality of drawn capillaries of the hollow-core optical fiber per change in the excess pressure ΔP_{excess}, satisfies the following:
$$0.9 \times ( Δ {P}_{excess} \times \frac{538.5}{{t}_{cap}} \times ( 3.78011 \times \frac{1}{σ} \times \frac{{U}_{d}}{{U}_{p}} ) ) \leq Δ {OD}_{cap} \leq 1.1 \times ( Δ {P}_{excess} \times \frac{538.5}{{t}_{cap}} \times ( 3.78011 \times \frac{1}{σ} \times \frac{{U}_{d}}{{U}_{p}} ) )$$
where σ is the draw stress in MPa, U_{d} is the fiber draw rate in mm/min, Uₚ is the preform feed rate in mm/min, and t_{cap} is a thickness of the plurality of drawn capillaries.

7. The method of claim 6, wherein the plurality of drawn capillaries have a target outer diameter OD_{cap} of about 26.0 μm.

8. The method of claim 6, wherein the ΔP_{excess} is from about 0.001 psig to about 0.02 psig.

9. The method of claim 6, wherein the hollow-core optical fiber has a cladding inner diameter ID_{cladding} of about 105 μm, a cladding outer diameter OD_{cladding} of from about 150 μm to about 300 μm, or both.

10. The method of claim 6, wherein the outer cladding has a cladding outer diameter OD_{cladding} of about 180 μm and the drawn capillary outer diameter sensitivity ΔOD_{cap} (in μm) satisfies the following:
$$0.9 \times ( Δ {P}_{excess} \times \frac{538.5}{{t}_{cap}} \times ( A \times 54677 \times {τ}^{- 1} ) ) \leq Δ {OD}_{cap} \leq 1.1 \times ( Δ {P}_{excess} \times \frac{538.5}{{t}_{cap}} \times ( A \times 54677 \times {τ}^{- 1} ) )$$
where A is a scaling factor and
$$A = \frac{{OD}_{preform}^{2} - {ID}_{preform}^{2}}{225} ;$$
τ is the draw tension in grams;
and t_{cap} is the thickness of the plurality of drawn capillaries.

11. The method of claim 10, wherein the plurality of drawn capillaries have a target thickness t_{cap} of 538.5 nm, and the drawn capillary outer diameter sensitivity ΔOD_{cap} (in μm) satisfies the following:
0.90×(ΔP_{excess}×(A×54677×τ⁻¹))≤ΔOD_{cap}≤1.10×(ΔP_{excess}×(A×54677×τ⁻¹))
where A is a scaling factor and
$$A = \frac{{OD}_{preform}^{2} - {ID}_{preform}^{2}}{225} ;$$
and τ is the draw tension in grams.

12. A method of producing a hollow-core optical fiber, the method comprising:
feeding a hollow-core preform into a draw furnace at a preform feed rate, wherein the hollow-core preform comprises an outer tube and a plurality of inner tubes disposed within the outer tube, wherein the outer tube has an outer diameter OD_{preform} and an inner diameter ID_{preform};
heating the hollow-core preform in the draw furnace;
drawing a hollow-core optical fiber from the hollow-core preform at a fiber draw rate, a draw tension τ, a core pressure P_{core} in a hollow-core of the hollow-core preform, and a capillary pressure P_{cap} in the plurality of inner tubes, thereby elongating the outer tube and the plurality of inner tubes of the hollow-core preform to produce the hollow-core optical fiber having an outer cladding, a plurality of drawn capillaries disposed within the outer cladding, and an interior cavity, wherein:
the plurality of drawn capillaries of the hollow-core optical fiber have an outer diameter OD_{cap} (in μm);
an excess pressure P_{excess} (in psig) is equal to a difference between the core pressure P_{core} (in psig) and the capillary pressure P_{cap} (in psig); and
a drawn capillary outer diameter sensitivity ΔOD_{cap} (in μm), which is defined as a variation in the outer diameter OD_{cap} of the plurality of drawn capillaries of the hollow-core optical fiber per change in the excess pressure ΔP_{excess}, satisfies the following formula:
$$0.9 \times ( Δ {P}_{excess} \times {( \frac{{OD}_{cap}}{26.} )}^{2} \times ( 3.78011 \times \frac{1}{σ} \times \frac{{U}_{d}}{{U}_{p}} ) ) \leq Δ {OD}_{cap} \leq 1.1 \times ( Δ {P}_{excess} \times {( \frac{{OD}_{cap}}{26.} )}^{2} \times ( 3.78011 \times \frac{1}{σ} \times \frac{{U}_{d}}{{U}_{p}} ) )$$
where σ is the draw stress in MPa, U_{d} is the fiber draw rate in mm/min, Uₚ is the preform feed rate in mm/min, and OD_{cap} is the target outer diameter of the plurality of drawn capillaries.

13. The method of claim 12, wherein the plurality of drawn capillaries have a target thickness t_{cap} of about 538.5 nm.

14. The method of claim 12, wherein the ΔP_{excess} is from about 0.001 psig to about 0.02 psig.

15. The method of claim 12, wherein the hollow-core optical fiber has a cladding inner diameter ID_{cladding} of about 105 μm, a cladding outer diameter OD_{cladding} of from about 150 μm to about 300 μm, or both.

16. The method of claim 12, wherein the outer cladding has a cladding outer diameter OD_{cladding} of about 180 μm and the drawn capillary outer diameter sensitivity ΔOD_{cap} (in μm) satisfies the following:
$$0.9 \times ( Δ {P}_{excess} \times {( \frac{{OD}_{cap}}{26.} )}^{2} \times ( A \times 54677 \times {τ}^{- 1} ) ) \leq Δ {OD}_{cap} \leq 1.1 \times ( Δ {P}_{excess} \times {( \frac{{OD}_{cap}}{26.} )}^{2} \times ( A \times 54677 \times {τ}^{- 1} ) )$$
where A is a scaling factor and
$$A = \frac{{OD}_{preform}^{2} - {ID}_{preform}^{2}}{225} ;$$
τ is the draw tension in grams,
and OD_{cap} is the target outside diameter of the plurality of drawn capillaries.

17. The method of claim 16, wherein the plurality of drawn capillaries have a target outer diameter OD_{cap} of about 26.0 μm and the drawn capillary outer diameter sensitivity ΔOD_{cap} (in μm) satisfies the following:
0.90×(ΔP_{excess}×(A×54677×τ⁻¹))≤ΔOD_{cap}≤1.10×(ΔP_{excess}×(A×54677×τ⁻¹))
where A is a scaling factor and
$$A = \frac{{OD}_{preform}^{2} - {ID}_{preform}^{2}}{225} ;$$
τ is the draw tension in grams.

18. The method of claim 12, wherein:
the draw tension τ in grams under which the hollow-core optical fiber is drawn is greater than or equal to about 50 g and less than or equal to about 600 g;
the differential core pressure P_{core} in a hollow core of the outer tube of the hollow-core preform is greater than or equal to 0.01 psig and less than or equal to 2 psig;
the fiber draw speed (U_{d} divided by 60,000) is greater than or equal to about 0.1 m/s and less than or equal to about 60 m/s;
the preform feed rate Uₚ is greater than or equal to 5 mm/min and less than or equal to 100 mm/min;
or any combination thereof.

19. The method of claim 12, wherein the draw furnace comprises a hot zone having an axial length greater than or equal to 3 cm and less than or equal to 50 cm.

20. The method of claim 12, wherein the hollow-core preform further comprises a nested capillary disposed within each of the plurality of inner tubes and in contact with an inner surface of each of the plurality of inner tubes of the hollow-core preform, wherein the drawing further elongates the nested capillaries of the hollow-core preform to form a drawn nested capillary of the hollow-core optical fiber in contact with an inner surface of each of the plurality of drawn capillaries of the hollow-core optical fiber.
